(19) United States
(12) Patent Application Publication
(10) Pub. No.: US 2012/0316938 A1
(43) Pub. Date: Dec. 13, 2012

(54) SYSTEM AND METHOD FOR USER-BASED DISCOUNT DEAL FORMATION AND ADVERTISING

(76) Inventor: Mehran Moshfeghi, Rancho Palos Verdes, CA (US)

(21) Appl. No.: 13/484,259

(22) Filed: May 30, 2012

Related U.S. Application Data
(60) Provisional application No. 61/495,045, filed on Jun. 9, 2011.

(51) Int. Cl. G06Q 30/02

(52) U.S. Cl. 705/14.16

(57) ABSTRACT

A system and method is described where an advertising server targets store coupon advertisements to people carrying wireless devices. In some embodiments the advertisement server tracks the position of several of its subscribed members in an area. The server then computes statistical measures, dynamically generates nearby store discount deals that match subgroups of the members or uses pre-existing deals from nearby stores, and forwards the deal advertisements to the wireless devices of the members. The advertised deals involve one or more items from the same store or multiple items from different stores. The members then use ad-hoc networking to build spontaneous social networks, advertise the deals to nearby shoppers, and get referral rewards. The advertising server also provides a portal shopping network web site where shoppers can search for deals, post their shopping/wish lists and deal referrals, and use forums to discuss products and stores.

### CLAIM OF BENEFIT TO PRIOR APPLICATIONS

The present Application claims the benefit of U.S. Provisional Patent Application 61/495,045, entitled, “System and Method for Discount Deal Advertisement, Referral, and Reward Sharing,” filed Jun. 9, 2010. The contents of U.S. Provisional application 61/495,045 are hereby incorporated by reference.

### BACKGROUND

Consumers who want to buy products are interested in getting the best deals on products or services that they are interested in. Recently many web-based deal advertising companies are offering deals to consumers with incentives to use centralized server-based social networking sites, such as Facebook™ and Twitter™, to publicize the deal to their friends and followers. Some of these companies, such as LivingSocial™, offer the incentive in the form of rewards, where if enough friends sign onto the deal then the referring person gets the deal for free or at a greater discount. Other deal advertising companies, such as Groupon™, require a minimum number of people to sign up for the deal in order to make the deal valid, which motivates someone interested in the deal to advertise the deal in order to reach the critical mass. Some deal advertising companies also use both incentives. The stores can also provide the same advertising themselves if they have sufficient traffic on their advertising channels (e.g., through their web site, email, etc.). This process benefits stores because it generates a new customer base and increases their sales volume. It also benefits buyers because they receive discounts on items they are interested in.

One of the limitations of these approaches is that the deals are offered by stores and advertised by deal advertising companies, or the stores themselves, without knowledge of the location of their subscribed members and other shoppers. The location of a person, however, is very important in brick and mortar shopping, since people are more likely to buy from stores that are in their close proximity. Another limitation of current deal advertising approaches is that they use traditional social networking where the deal is recommended or forwarded to one's friends. However, most of those friends are not going to be physically near the recommended stores. On the other hand, if a person is near a deal store then there are many other shoppers nearby that are not his/her friend but who may be looking for similar deals and coupons. Yet another limitation is that existing approaches do not allow the deal referral reward to be negotiated and shared between the referrer and the buyer. This is, however, something that happens in human transactions where a sales person may share some of his/her commission with the buyer in order to make the deal happen.

### BRIEF SUMMARY

Some embodiments provide a system and method where an advertising server targets store coupon advertisements to people carrying wireless devices. In some embodiments the advertisement server tracks the position of several of its subscribed members in an area. The server then computes statistical measures, dynamically generates nearby store discount deals that match subgroups of the members or uses pre-existing deals from nearby stores, and forwards the deal advertisements to the wireless devices of the members. The advertised deals in some embodiments involve one or more items from the same store or multiple items from different stores. The members then use ad-hoc networking to build spontaneous social networks, advertise the deals to nearby shoppers and get referral rewards from the advertisement server company or the stores. The advertising server also provides a portal shopping network web site where shoppers can search for deals, post their shopping/wish lists and deal referrals, and use forums to discuss products and stores.

Some embodiments provide a system and method where the members of an advertising server that markets store deal coupons use conventional wired/wireless networking and ad-hoc networking to build spontaneous social networks, advertise the deals to other shoppers, and get referral rewards. A shopper who receives the referral advertisements and is not a member can register and advertise the deal further to other shoppers to get rewards. A referring member can specify the percentage of the referral reward she plans to share with the buyers. The referring member can specify different reward sharing percentages for the same deal to different buyers. A shopper who receives multiple referrals of the same deal from different members can negotiate and buy the deal with the referral that gives her the best shared reward. A shopper can perform an indirect self-referral where the shopper networks and finds another user to refer him to a deal that has a referral reward and they share the referral reward together. A member can also use a peer-to-peer connection to find other users to share the purchase of items with.

Some embodiments provide a system and method where the members of an advertising server that markets store deal coupons use peer-to-peer wireless networking to advertise the deals to nearby shoppers and get referral rewards. The member who makes the referral (seller) and the shopper who purchases the deal (buyer) use an ad-hoc social networking application on their mobile devices to exchange profiles. A profile matching component running on their mobile device alerts a buyer/seller of a match with a nearby seller/buyer. The system also rewards shoppers whose mobile devices are used as routers in a multi-hop ad-hoc network that connects the seller to the buyer.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an overview of a system of some embodiments of the invention.

FIG. 2 conceptually illustrates a more detailed view of the mall section of FIG. 1 in some embodiments of the invention.

FIG. 3 conceptually illustrates an example deal targeted to a member user in some embodiments of the invention.

FIG. 4 conceptually illustrates the interface after he clicks on the “Refer a Friend and Get Rewards” link in FIG. 3 in some embodiments of the invention.

FIG. 5 conceptually illustrates an interface for displaying user account information after the user in FIG. 3 clicks on the “Your Account” link in some embodiments of the invention.

FIG. 6 conceptually illustrates a process for deal referral and reward sharing in some embodiments of the invention.

FIG. 7 conceptually illustrates a process for providing indirect self-referral in some embodiments of the invention.

FIG. 8 conceptually illustrates two mobile devices using ad-hoc networking and profile matching to share shopping deals and rewards in some embodiments of the invention.

FIG. 9 conceptually illustrates an example of a deal referral profile in some embodiments of the invention.

FIG. 10 conceptually illustrates an example of a shopping profile in some embodiments of the invention.

FIG. 11 conceptually illustrates an example of settings for the ad-hoc social networking application in some embodiments of the invention.

FIG. 12 conceptually illustrates the position of shoppers of FIG. 2 at a later time instance, where a user uses his mobile device and an ad-hoc social networking application to advertise a deal to nearby unregistered users.

FIG. 13 conceptually illustrates an example of an alert message on the mobile device of a potential buyer indicating a match between his shopping profile and the referral profile of a nearby user in some embodiments of the invention.

FIG. 14 conceptually illustrates a non-member is referred to a deal by a member. The non-member views the personalized deal advertisement using his/her mobile device's browser or an installed application.

FIG. 15 conceptually illustrates the position of the shoppers of FIG. 12 at a later time instance demonstrating further advertisement of the deal with ad-hoc networking

FIG. 16 conceptually illustrates a process for providing P2P networking among shoppers in some embodiments of the invention.

FIG. 17 conceptually illustrates the position of the shoppers of FIG. 15 at a later time instance and demonstrates deal advertisement with multi-hop social networking

FIG. 18 conceptually illustrates an example of a referral setup to share rewards with a purchaser as well as intermediate routers in some embodiments of the invention.

FIG. 19 conceptually illustrates users receiving multiple referrals for the same deal from different members in some embodiments of the invention.

FIG. 20 conceptually illustrates the same process of FIG. 19 for conventional server-based social networking referrals in some embodiments of the invention.

FIG. 21 conceptually illustrates a process for a product and store-based approach in some embodiments of the invention where the deal server tracks members and forwards store deals to the members.

FIG. 22 conceptually illustrates a process of the deal server in some embodiments of the invention to allow users to login to deals and either purchase a deal or forward it to other members and non-members.

FIG. 23 conceptually illustrates a process for deal referrals by a first deal recipient to other shoppers in some embodiments of the invention.

FIG. 24 conceptually illustrates a process in some embodiments of the invention for a user-based approach.

FIG. 25 conceptually illustrates the advertisement in some embodiments of the invention where a tracked member has moved to a new location.

FIG. 26 conceptually illustrates advertisement in some embodiments of the invention for a tracked member.

FIG. 27 conceptually illustrates advertisement on a mobile device of a tracked member in some embodiments of the invention.

FIG. 28 conceptually illustrates an example of deal advertising in some embodiments of the invention.

FIG. 29 conceptually illustrates deal advertising by several different deal advertising servers in some embodiments of the invention.

FIG. 30 conceptually illustrates a block diagram of a user's wireless mobile device in some embodiments of the invention.

FIG. 31 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a system and method where an advertising server targets store coupon advertisements to people carrying wireless devices. In some embodiments the advertisement server tracks the position of several of its subscribed members in an area. The server then computes statistical measures, dynamically generates nearby store discount deals that match subgroups of the members or uses pre-existing deals from nearby stores, and forwards the deal advertisements to the wireless devices of the members. The advertised deals in some embodiments involve one or more items from the same store or multiple items from different stores. The members then use ad-hoc networking to build spontaneous social networks, advertise the deals to nearby shoppers and get referral rewards from the advertisement server company or the stores. The advertising server also provides a portal shopping network web site where shoppers can search for deals, post their shopping/wish lists and deal referrals, and use forums to discuss products and stores.

Some embodiments provide a system and method where the members of an advertising server that markets store deal coupons use conventional wired/wireless networking and ad-hoc networking to build spontaneous social networks, advertise the deals to other shoppers, and get referral rewards. A shopper who receives the referral advertisements and is not a member can register and advertise the deal further to other shoppers to get rewards. A referring member can specify the percentage of the referral reward she plans to share with the buyers. The referring member can specify different reward sharing percentages for the same deal to different buyers. A shopper who receives multiple referrals of the same deal from different members can negotiate and buy the deal with the referral that gives her the best shared reward. A shopper can perform an indirect self-referral where the shopper networks and finds another user to refer him to a deal that has a referral reward and they share the referral reward together. A member can also use a peer-to-peer connection to find other users to share the purchase of items with.

Some embodiments provide a system and method where the members of an advertising server that markets store deal coupons use peer-to-peer wireless networking to advertise the deals to nearby shoppers and get referral rewards. The member who makes the referral (seller) and the shopper who purchases the deal (buyer) use an ad-hoc social networking application on their mobile devices to exchange profiles. A profile matching component running on their mobile device alerts a buyer/seller of a match with a nearby seller/buyer. The system also rewards shoppers whose mobile devices are used as routers in a multi-hop ad-hoc network that connects the seller to the buyer. Several more detailed embodiments of the invention are described in sections below.

### I. Overview

A. Different Actors

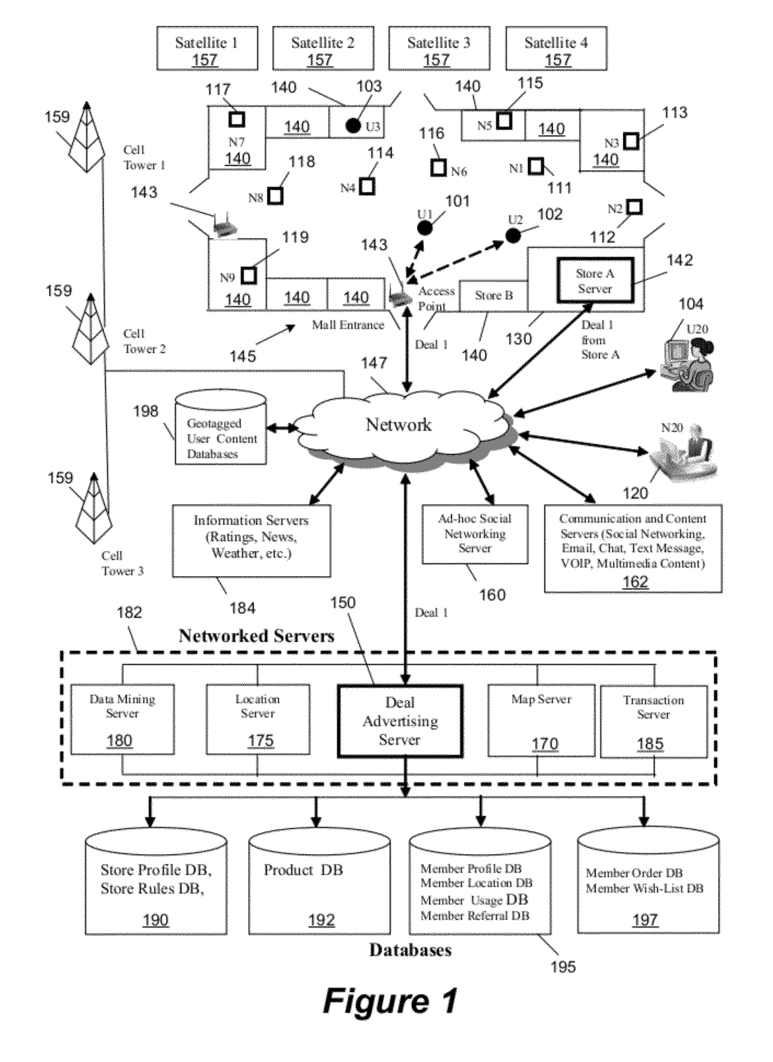

FIG. 1 conceptually illustrates an overview of a system of some embodiments of the invention. The figure shows a group of retail stores 130-140, a group of users 101-104 and 111-120, a deal advertising server 150, and an ad-hoc social networking server 160. Retail stores sell goods and services (referred to as items) at individual locations or in a shopping area such as a mall 145. Several stores are shown and deal 1 by store A 130 is being advertised in the example of FIG. 1. However, there can be any number of stores and deals. Throughout this Specification, the term deal is referred to one or more items which are offered for purchase. The items in a deal include products, services, or both. Also the terms “item for purchase” or “item for sale” mean an item such as a product (or service) that the seller is willing to sell (or provide) for a given price (or as described below, an item that a referring user is referring to another user in order to receive rewards). The terms for purchase, for sale, or deal do not require an item to be sold at a bargain or reduced price although nothing in the disclosed embodiments prevents a seller offering an item at a reduced or discounted price in order to encourage higher sales.

FIG. 1 also shows several users with mobile or non-mobile devices that are potential buyers of goods and services from the retail stores. The users fall into two general categories: (i) registered members with the deal advertising server or stores and (ii) non-members. Registered members can also become sellers by making advertisement referrals. FIG. 1 shows three registered members 101-103 (U1, U2 and U3) in the mall, a registered member 104 (U20) at a different location, nine non-members 111-119 (N1-N9) in the mall, and a non-member 120 (N20) at a different location. However, there can be any number of each type of users. Some of the users shown in this example are moving around an environment with retail stores. FIG. 1 illustrates pedestrians in a mall but in other situations some users are outside the mall (e.g., in moving vehicles). The users are carrying location-aware mobile devices that have one or more wireless transceivers. The mobile devices are wireless phone, tablet personal computer (PC), personal digital assistant (PDA), PC laptop, personal audio/video device, digital still/video camera, or some other wireless device that is network capable and sends and receives information.

FIG. 1 further shows a deal advertising server 150 that is an agent between the stores and the server's members and dynamically generates deals or targets existing coupon deals from the stores to the mobile devices of the members. This server has access to a number of other networked servers such as a map server 170, a location server 175, a data mining server 180, and a deal transaction server 185. The servers perform different functions. The servers in some embodiments are separate processes that run on separate computers, while in other embodiments several servers run on a single computer.

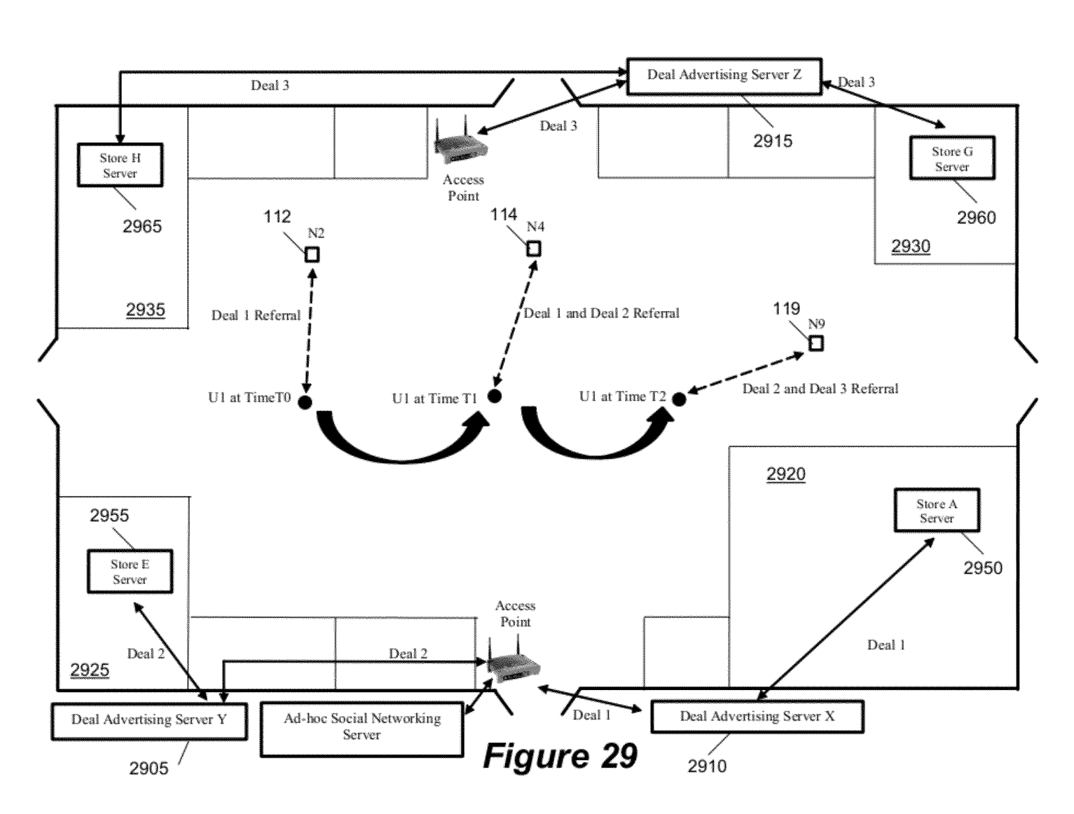

These servers access a group of databases 190-198 that contain information about store profiles, deal rules, and products in some embodiments. The databases also contain information about members such as their profiles, location history, usage history, referral history, orders and purchases, and shopping/wish-lists. Wish-lists are non-urgent items members are interested in buying at a discount in the future, while shopping lists are items they want to buy in the near-term. In a wide scale deployment scenario the system covers users and retail stores that are in different countries, states, counties, cities, zip codes, malls, etc. Some embodiments include multiple deal advertising companies that compete with each other for a given geographic region and location (as shown by reference to FIG. 29, below). The same deal advertising company also has local deal servers for different geographic regions and locations in some embodiments. In some of these embodiments, a user can act as a deal aggregator and refer deals from several vendors to other users (e.g., by using his/her mobile phone and an ad-hoc social network).

B. Wireless Ad-Hoc Networking

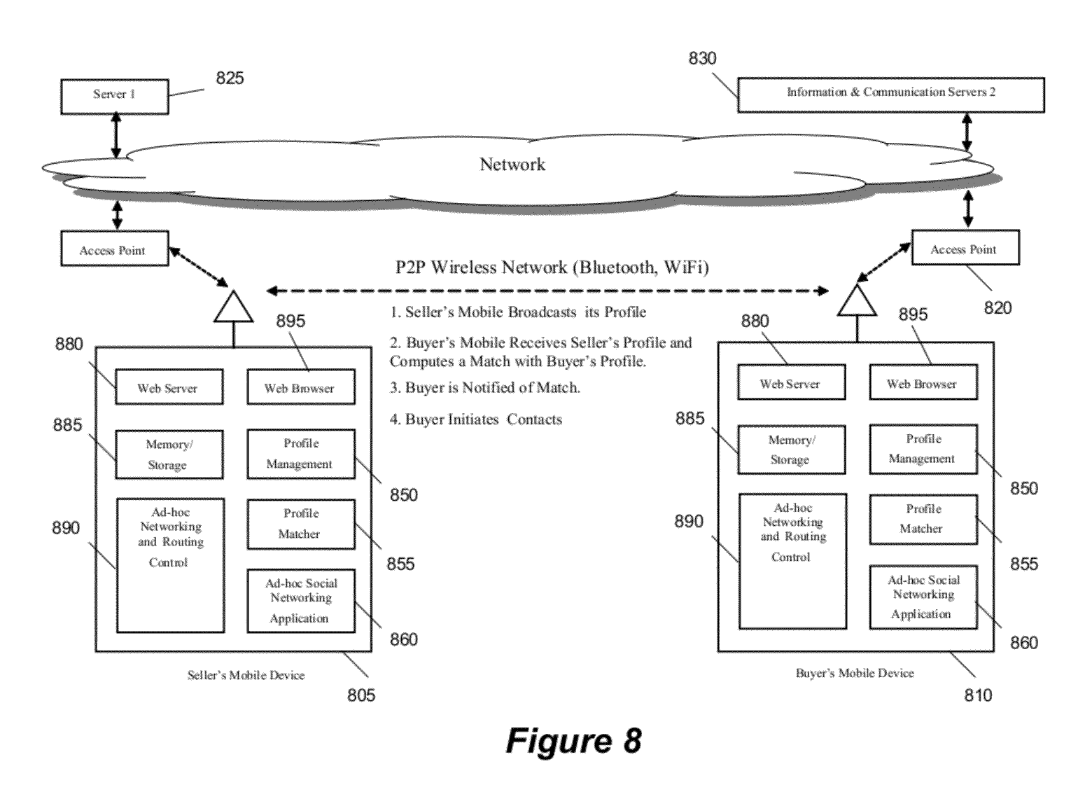

FIG. 1 shows an ad-hoc social networking server 160 that provides an ad-hoc social networking application (as described in further details by reference to ad-hoc social networking application 860 in FIG. 8) for the mobile devices of all users. This application allows the users to use their mobile devices and communicate directly without an access point (e.g., by using Bluetooth® or Wi-Fi direct communications). Users in some embodiments build spontaneous social networks with other users (e.g., in their immediate area) and advertise to each other. A user can be a shopper that is looking for coupon advertisements, a seller that is selling advertisements through referrals, or both. The seller and the buyer use the ad-hoc social networking server 160 to download the ad-hoc social networking application or equivalent browser code/plug-in. The ad-hoc social networking server 160, however, does not facilitate communication between the mobiles in some embodiments. The seller and the buyer in some embodiments provide their emails for notifications about software updates to ad-hoc social networking application. In some embodiments, ad-hoc social networking application has an automatic update feature which updates ad-hoc social networking application when devices (e.g., devices 810 and 805 described by reference to FIG. 8, below) are connected to network 147 and server 160.

FIG. 1 also shows conventional infrastructure networks 147 involving wired and wireless networks with access points and/or cell towers. In addition to these networks, the wireless devices also communicate using wireless ad-hoc networks in some embodiments. Wireless Ad-hoc networking, sometimes referred to as peer-to-peer (or P2P) networking, allows mobile devices to directly communicate with each other (i.e., communication is performed by establishing a communication channel between two devices and sending signals from an antenna of the first device to an antenna of the second device without the signals going through any other intervening infrastructure Wi-Fi access points or cellular base-stations). An ad-hoc network can grow and shrink and without having to make any requests or reports to a central authority. When mobile wireless devices are operating in ad-hoc mode they act as network nodes that discover and communicate with other wireless network nodes that are within certain range. This communication in some embodiments happens in P2P mode without requiring an infrastructure wireless access point and/or router. Bluetooth® and some embodiments of Wi-Fi standards such as Wi-Fi Direct provide P2P connectivity without a need for an access point. Other embodiments use other wireless standards that provide P2P connectivity.

Ad-hoc networks in some embodiments use an access point or gateway to connect to the Internet (but not to provide a direct communication link between two wireless mobile devices). A wireless mobile device (e.g. a cellular phone of a user) that acts as a peer network node is also used in some embodiments to connect together other wireless mobile devices in an ad-hoc network. These intermediate wireless mobile devices are utilized to connect other wireless mobile devices to each other even when the users of the intermediate wireless mobile devices are not involved in the communication regarding a deal. In other words, these wireless mobile devices are “pass-through” user devices that act as ad-hoc peer network nodes. This type of ad-hoc network is referred to as a multi-hop ad-hoc network. Again, in these embodiments, communication between two wireless mobile devices is either directly between the wireless mobile devices (i.e., communication is performed by sending a signal from an antenna of a first device to an antenna of a second device without the signal going through any other intervening devices) or through one or more other wireless mobile devices that are used (i) as wireless communication devices by users and (ii) as ad-hoc peer network nodes to link the wireless mobile devices of other users together. In other words, signals exchanged between the wireless mobile devices of the users of the P2P network in some embodiments travel through the air or through the mobile device of other users of the P2P network, but not through any other electronic devices such as infrastructure Wi-Fi access points or cellular base-stations.

Bluetooth® provides short-range P2P connections between mobile devices. A Bluetooth® network is made up of small subnets or piconets. A piconet includes two or more connected nodes sharing the same channel. In some embodiments, a piconet includes one channel for transmitting and another for reception. Every piconet has one master and several slaves, where the slaves use the master to communicate with each other. Two or more piconets that have a node in common can connect with each other to form a scatternet. A slave node in one piconet can be a master node in another piconet. Bluetooth® 4.0 standard uses AES 128-bit encryption and claims speeds of 25 Mbps. The range of Bluetooth® is dependent on power and Bluetooth®-class and is typically of the order of 10-200 feet.

Wi-Fi Direct is also a standard from the Wi-Fi alliance that allows a mobile device to advertise itself as a combination of software access point and peer. Thus, a mobile device with Wi-Fi Direct can have a P2P connection to another mobile device, while having a wireless local access network (WLAN) connection to an infrastructure network via an access point. The standard is easier to configure than previous ad-hoc methods and claims regular Wi-Fi speeds of up to 250 Mbps. It also provides security with Wi-Fi Protected Access 2 (WPA2) encryption and Wi-Fi Protection Setup (WPS) secure key handling. Wi-Fi Direct improves on the earlier WLAN 802.11 Ad-hoc by providing better interoperability and ease-of-use. IEEE 802.11z “Direct Link Setup” is also the 802.11 Working Group's take on improving ad hoc connections. The terms WLAN, 802.11 and Wi-Fi refer to the same set of wireless standards are used interchangeably here.

The use of the ad-hoc or P2P network is advantageous if a Wi-Fi access point or cellular network is not available. Also, a P2P connection such as a Bluetooth® connection to a nearby user may require less power than Wi-Fi or cellular systems. Furthermore, the use of a conventional network to identify nearby users requires that a central server track the users. However, the users may not want their location to be tracked and the use of P2P network enables the users to communicate with other nearby users without being tracked by a centralized server. Therefore, a user can explicitly disable location tracking by the user's mobile device and still communicate with other users to use the disclosed P2P deal advertising and reward sharing embodiments.

In some embodiments a social networking application is used to configure wireless devices to communicate in ad-hoc mode and to use the same wireless network and channel when sharing information with each other. The application handles both static mobile nodes as well as moving mobile network nodes. The application is lightweight in order to be suitable for multiple mobile devices and wireless environments. The application enables the mobile devices of different users to find and communicate with each other. The social networking application is stored on the server of a company that is typically different from the deal advertising company. However, in some embodiments a social networking company also advertises deal coupons. Likewise, in some embodiments a deal advertising company provides its own social networking web site and ad-hoc mobile applications.

Although several examples of shopping coupon advertisements are used to describe the invention, the disclosed ad-hoc social networking method is used for other applications such as job search, romance, and sharing music/video/game content in some embodiments. In each case, ad-hoc social networking is used where a first user is an indirect offeror or seller and refers a second user to a web server to find something (shopping coupon, job, romance partner, music/video/game content) in exchange for a commission such as rewards. This ad-hoc social networking application in some embodiments is used where a first user is a direct seller to a second user. For example, first user has an item that second user wants to buy, or first user has a job opening that second user wants to fill, or first user and second user have profile characteristics that match for a romantic relationship, or first user has music/video/game content that second user wants to copy/purchase. The ad-hoc social networking application in some embodiments is also used where the first user acts as a middleperson that is only referring a deal for a product, service, or social or networking connection that the first user is aware of and believes that might suit the second user (e.g., based on the second user's profile).

In describing different deal referral and reward sharing, ad-hoc networking, multi-hop networking rewards systems, and peer-to-peer networking embodiments throughout this specification, a user referred to as a seller is not necessarily a user that has a merchandize or a service to sell. Instead, the user might be a user that is referring a merchandize or service sold by another user or a merchant, company, web site and attempting to collect referral fees and share the reward. For brevity, such a user is sometimes referred to as a seller but it should be understood that the user might be simply acting as a middle person by referring a merchandize or service to other users.

The mobile devices use wireless networks to communicate with different servers in some embodiments. These servers include networked servers 182, ad-hoc social networking servers 160, communication and content servers 162 (for social networking, email, chat, text messaging, Voice over Internet Protocol (VoIP), sharing multimedia content, etc.), and general information servers 184. FIG. 1 illustrates a geographic area that has multiple wireless networks. Some of these networks are more suitable for outdoor environments while others are more robust inside malls and buildings. The networks shown include Global Positioning System (GPS), Cellular, WLAN 802.11 or Wi-Fi.

Four GPS satellites 157 are shown in FIG. 1. Three cellular towers 159 are also shown in the figure, but small cellular base-stations called Femtocells are also used in order to improve cellular coverage in indoor areas in some embodiments. Two Wi-Fi access points 143 are also shown in the figure, but in some embodiments each store can have several access points.

Other networks that are used in some embodiments include Bluetooth®, Radio Frequency Identification (RFID), Worldwide Interoperability for Microwave Access (WiMax), Ultra-wideband (UWB), and 60 GHz. Each type of network can also have different implementations. For example, the WLAN 802.11 standard (also referred to as Wi-Fi) can include 802.11b, 802.11a, 802.11g, 802.11z, 802.11n and Wi-Fi Direct. The cellular network can include Code Division Multiple Access (CDMA), CDMA2000, Wideband CDMA (WCDMA), Time Division Multiple Access (TDMA), Frequency Division Multiple Access (FDMA), and other multiple access techniques.

Users inside the mall of FIG. 1 use their mobile devices and Wi-Fi access points in hot spot areas to connect to the Internet in some embodiments. Users with data plans also use the cellular network to connect to the Internet in some embodiments. A deal advertising company uses its deal server and a network, such as the Internet or an Intranet, to communicate with the servers of the stores (e.g., store A server 142) and the communication devices of its registered members. The deal server uses a location server 175 to estimate the location and velocity of all its members. The deal server 150 then dynamically generates nearby store discount deals that match subgroups of the members or uses existing nearby store deals, and forwards relevant deal advertisements to the wireless devices of the members. Since members advertise the deals further to near-by non-members the stores can lower their usual deal offering thresholds.

C. Database Information

In FIG. 1 the deal server 150 has access to a number of information categories, which are stored in one or more database tables on one or more physical machines. For simplicity some of the databases are shown together in the figure. For instance, member profile database, member location database, member usage database, and member referral database are shown together. Similarly, member order database and member wish-list database are shown together. It will be obvious to a person of ordinary skill in the art that the information in these databases or tables can be stored in separate databases and/or tables.

1. Member Profile Database

Member profile database 195 has member registration identification information such as name, billing address, payment methods, home/work street address, email, instant message ID, and phone number, as well as demographics and interests. A member can use his/her mobile device or other computing device at home or work to update this information. The data mining server 180 in some embodiments also analyzes the usage and order history of a member to update the member profile information. The data mining server may also be able to access the databases of the networked communication servers in order to update the member profile information.

2. Member Location Database

Member location database 195 in some embodiments has the member's position and velocity at different time instances, and the default home/work locations. A location server polls the member's mobile device, or the member's device broadcasts its position and velocity. If the mobile device pushes its position information then two or more position values at consecutive time instances are used to estimate velocity in some embodiments.

3. Member Usage Database

Member usage database 195 keeps a log of how a member interacts with the advertising server such as its discount deal web pages and messages.

4. Member Referral Database

Member referral database 195 keeps a log of the member's referral history. The referral history in some embodiments includes the average number of referrals by each member, total number of referrals for each member, the conversion rate of those referrals to purchases, and the dollar amount of the resulting purchases. Members with a high referral history are valuable advertising members. They, therefore, receive notifications about more deals, many of which they may not be interested in but may refer to other shoppers in return for rewards.

5. Member Order Database

Member order database 197 includes previous purchases of members and current subscribed deals/orders.

6. Member Wish-List Database

Member wish-list database 197 has wish-list and shopping list items which the members have registered with the deal advertising server.

7. Product Database

Product database 192 has information about different products. The information includes a product ID, product category and subcategory, product name, product description, product manufacturer, product barcode, and product photos. A store uses its server computer and a network to communicate with the deal advertising server and update its information.

8. Store Profile Database and Rule Database

Store profile database and rule database 190 have information about each store such as location, products, discount items, and discount rules. A store uses its server computer and a network to communicate with the advertising server and update its information.

9. User Content Databases

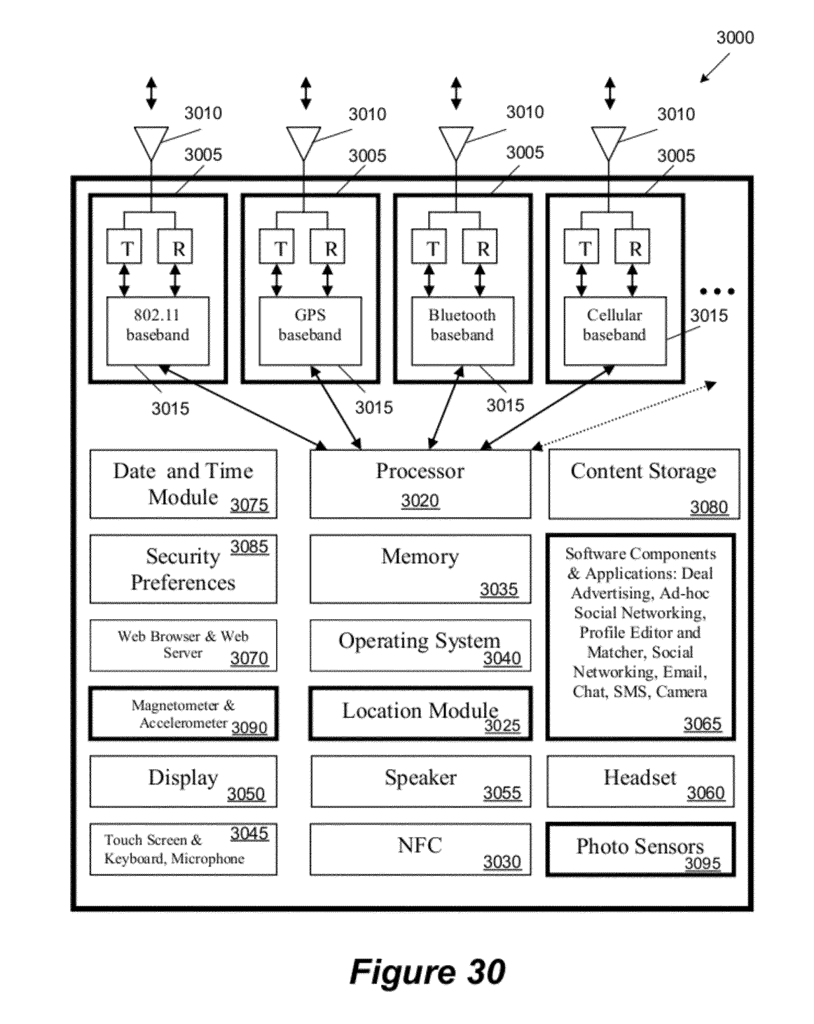

User content databases 198 are used to store user content. In some embodiments, content generated by user device applications such as email, chat, SMS, social networking tools, and camera are complemented (e.g., geotagged) with location, orientation, velocity, and date/time information if the user/member chooses to do so by setting the appropriate security preferences (as described by reference to FIG. 30, below).

### II. User-Based Group Deal Formulation and Advertising

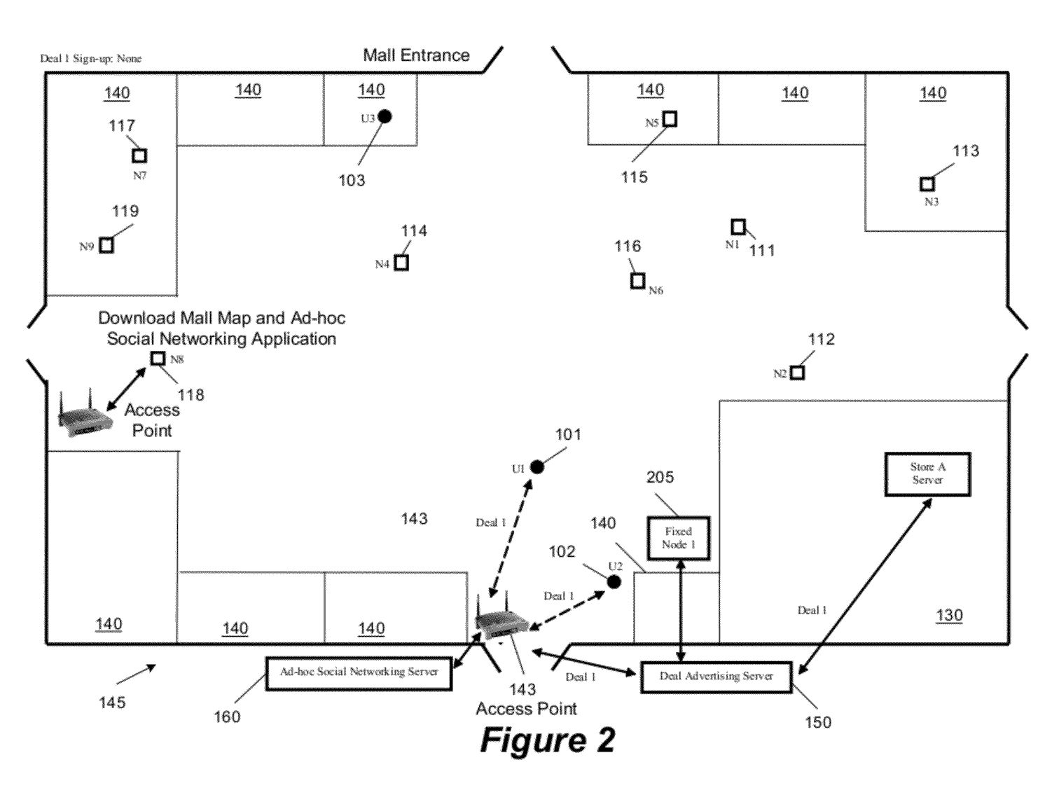

FIG. 2 conceptually illustrates a more detailed view of the mall section of FIG. 1 in some embodiments of the invention. Specifically FIG. 2 illustrates a more detailed view of the mall in FIG. 1 showing deal server members (U1-U3) 101-103 and unregistered mall shoppers (N1-N9) 111-119 without showing details of the outside networks because of space limitations.

In FIG. 2 the deal server 150 uses the mall's networked access point 143 or the cellular network (if the members have data plans and choose that network for data connectivity) to notify members about the deal 1 advertisement from store A 130. The deal server 150 also uses fixed location transmitter node 1 205 to broadcast the deal to nearby mobiles that are within its transmission range. This deal may be dynamically generated by contacting store A 130, or it could be a pre-existing store A deal. In both cases the deal server 150 uses the users' locations and profiles in determining a match between the deal and the members. Different members receive advertisements about different deals based on their location, purchase history, referral history, wish-lists, shopping lists, and other profiles. In this example, deal server members U1 101 and U2 102 receive an advertisement on their mobile devices about the deal from store A 130 because they are potential buyers of the advertisement and/or because they are potential referrers to other shoppers. Members U1 101 and U2 102 then have the option to purchase the deal, and/or use ad-hoc social networking to advertise the deal to near-by shoppers (non-members N1-N9 111-119). Member U3 103 does not receive the advertisement from the deal server because his/her profile or location (too distant from store A) does not match the advertisement.

Some registered members may also not receive advertisements because they do not have network connectivity or because they have disabled position tracking and the deal advertising server does not know their location. As described by reference to FIG. 1, member U20 104 and non-member N20 120 are at locations other than the mall 145 (e.g., home, office, or mobile but at a different place). In some cases these users also receive advertisements either directly from the deal advertising server 150 or through member referrals with standard networking infrastructure and communication servers 162 (email, chat, text message, a shopping portal web site, conventional server-based social networking). For example, member U1 101 can use his/her mobile device and server-based social networking such as Facebook™ to send his/her friends U20 104 and N20 120 the deal 1 advertisement message. Users U20 104 and N20 120 then use their computing devices to register (only N20 120 since he is not a member), sign up for deal 1, and then later go to the mall to pick up their purchased items.

A. Example Deal

The deal advertisement sent out to members is through email, text or instant message with a URL link to the deal web page, voice message, social networking (e.g., Twitter™, Facebook™), applications, web pages, etc. The deal server 150 and the associated data mining server 180 choose the optimum method of advertisement notification for each user in order to get the highest level of participation (e.g., one or more of email, text or instant message, voice message, social networking, as well as less intrusive pull-based applications and deal server's portal web pages and messaging system). Each member also sets this in his/her account settings in some embodiments. If there are multiple deals from one or more stores a member either receives one advertisement for all the deals that includes a graphical dynamic map with the location of all nearby deals, or alternatively receives separate advertisements for each deal.

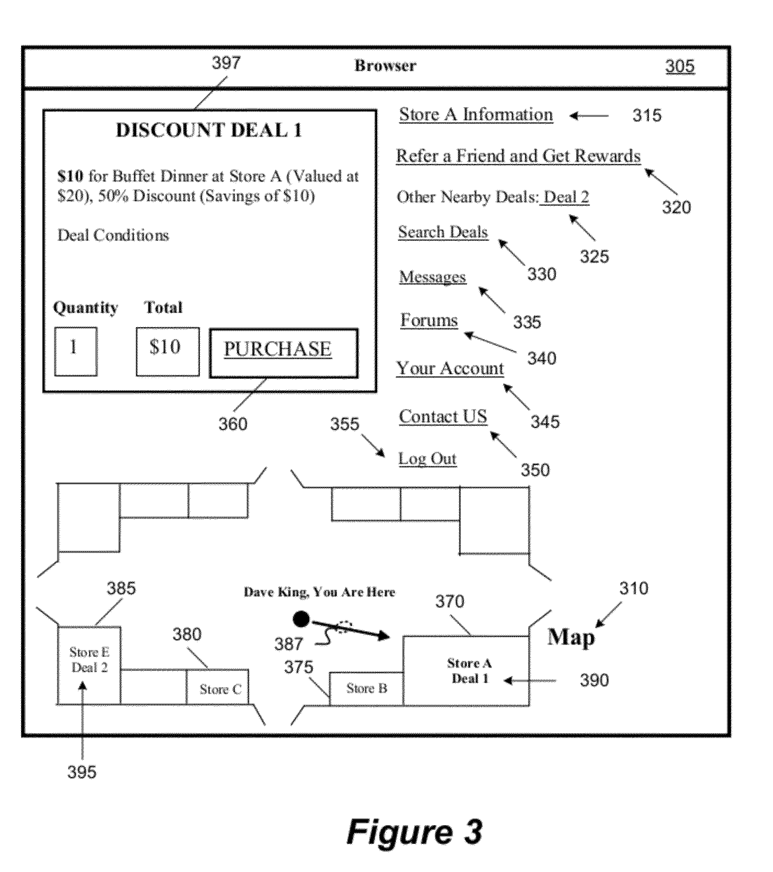

FIG. 3 conceptually illustrates an example deal targeted to a member user in some embodiments of the invention. The figure shows a tracked deal advertising server member, Dave King (e.g., user U1 101 in FIG. 1), is notified about deal 1 from store A 130 and views the advertisement using his mobile device's browser 305 or an installed application.

This user is using a software program on his mobile device to view discount deals as he moves around a shopping area. This software is code running on a browser in some embodiments. In other embodiments, the software is a mobile device application that is running a session with the deal advertising server. In this figure the user is authenticated with the deal server and sees personalized deal advertisements. The map server 170 of FIG. 1 uses the position and velocity information of the user and uses a map database to generate the dynamic map 310 shown in FIG. 3. The confidence in the user's position in some embodiments is conveyed on the maps with different methods such as color coding or a circle with a radius that increases with position uncertainty. The map in some embodiments displays one or more of the member's name, position, travel direction, and provides directions to the deal of interest. The speed of the user is conveyed with different methods in different embodiments such as the length of a direction arrow 387 or numerical overlays on the map.

The map also displays nearby stores 370-385 and nearby deals 390-395 in some embodiments. In this example, deal 1 390 which is the nearest deal at store A 370 is featured. The featured deal has a description 397 of the deal that states the cost to the user and the savings of the deal compared to a regular price. The deal conditions are also noted such as one or more of the duration of the deal, number of items available, required minimum number of items requested by buyers to activate the deal, and the discount function. Deal 1 is a 50% discounted buffet dinner at store A. Another relevant deal (deal 2 395 at store E 385) that is somewhat further away is also marked on the map. The member may filter the deals or select a particular one and receive directions to the store and also directions inside the store to get to the deal item. If a user buys a gift card from the deal advertising server she can visit the store to pick store items and use her electronic receipt. Once she is at the store she can use her mobile device to scan and price items. For example, the mobile device in some embodiments uses a built-in camera or a scanner to scan the barcodes of items. Alternatively, if the items have RF tags (e.g., radio frequency identification, RFID tags) with price information she can use her mobile device with an RF tag reader to scan the prices. After the user has picked the store items she can use the Near Field Communication (NFC) component of her mobile device, which acts as a smart card, to communicate with a store reader and exchange the gift card receipt for the items. If the items cost more than the gift card she can pay the additional amount with a mobile device NFC card payment method.

In FIG. 3 the discount deal promotion shows a web link 315 that when clicked shows information about the deal promotion store. Another link 320 is provided for making referrals and getting rewards (cash, coupons, reward points). There are other links that show nearby deal information 325, search for deals 330, provide a deal advertising server specific messaging system 335, provide forums 340, allow the user to view account information 345 (previous transactions, rewards, personalization settings, personal information, etc.), provide contact information 350 for the deal advertising company, and log the user out 355.

Members use the deal advertising server's messaging system for receiving deal notifications from the server as well as to send/receive messages to/from deal server, other members and unregistered users. Registered users also use the forums link 340 to create and view moderated or non-moderated forums, groups, clubs and communities dedicated to shopping. The users in some embodiments use the forum section to perform general shopping social networking with other users (chat, email, etc.). Unregistered users in some embodiments also view these but would have to register to create their own content and reply to others. For instance, shoppers post their shopping lists, wish-lists, and deal referrals and review/discuss products/stores. Registered users also use the “Your Account” section to manage their rewards, such as purchasing items or exchanging/transferring them with other users.

The web site of the deal advertising server effectively becomes a shopping network portal web site in some embodiments. The advertising company uses this web site as the mechanism for notifying users about deals. Thus, instead of sending intrusive push advertising in the form of multiple emails and SMS messages, users in a pull fashion visit the regular web site at home/work or view the mobile version of the web site on their mobile device when they enter a shopping area (as described by reference to FIGS. 3-4, 14, and 25-27) and see relevant nearby deals. The deal server's messaging system is also used by the deal server to notify members about deals and other information in some embodiments. Thus, when users log into their deal server account they can see that they have messages in their messages inbox (e.g., by using the Messages link in FIGS. 3 and 25-27). Users can also send messages out to other registered members. The messaging system can also interface to a regular email system so members can send messages to non-member's email accounts. Registered members can set in their account preferences section how they should receive deal server notifications and information (e.g., only deal server's messaging system, email, both, etc.).

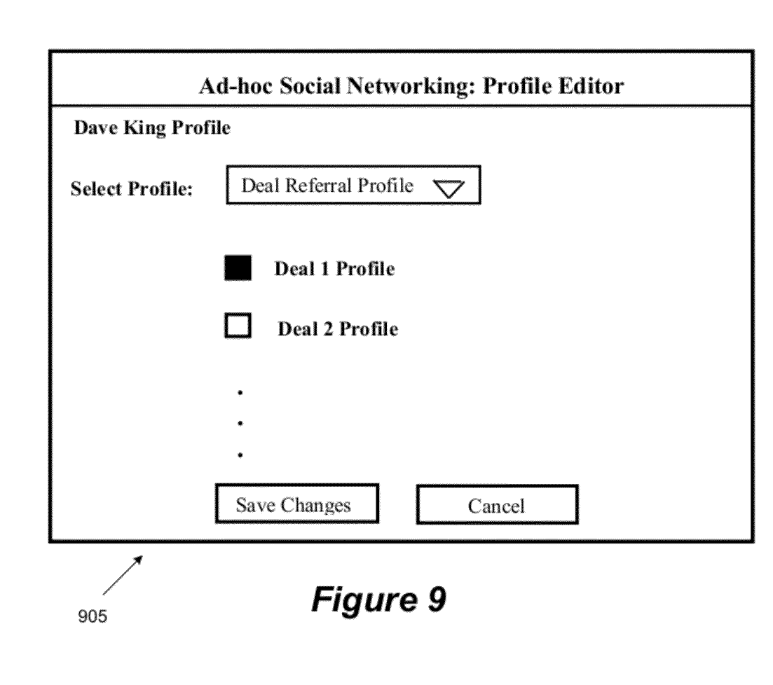

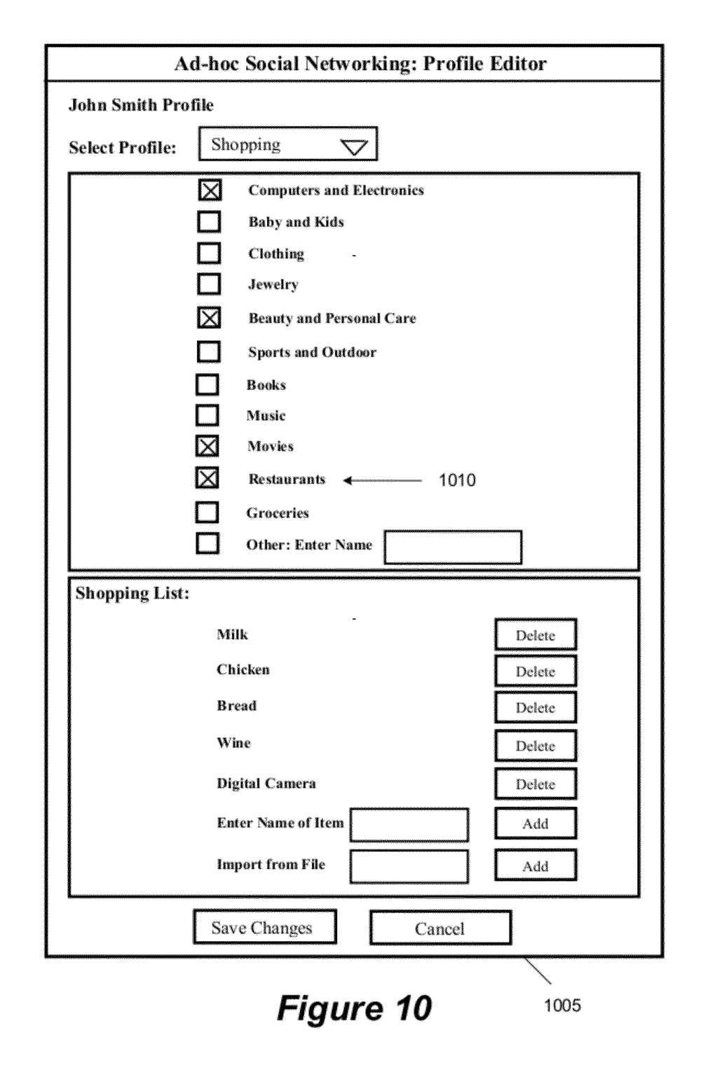

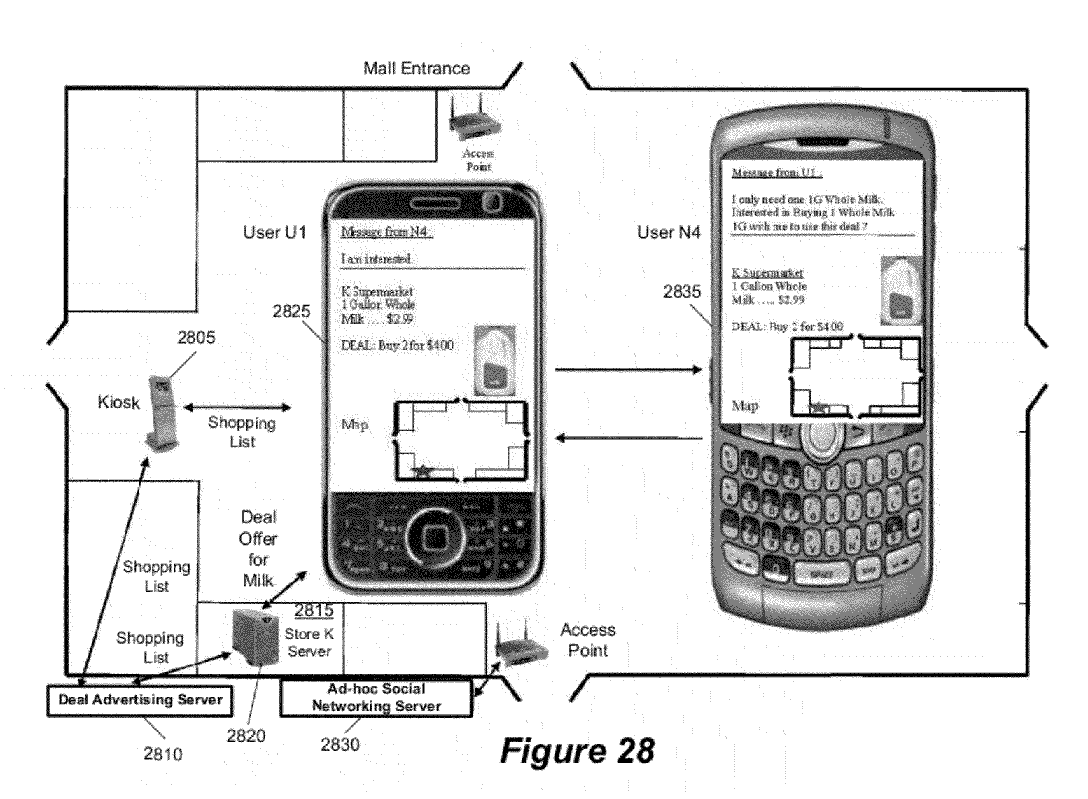

In some embodiments, a deal aggregator web site is maintained on a server that is separate from the deal advertising server. Registered users of this portal web site then view deals advertised by different deal advertising server companies (FIG. 29), deals advertised directly by the stores (FIG. 28), and deals (FIG. 9) and wish-lists/shopping-lists (FIG. 10) advertised directly by users. Thus, instead of users registering with multiple deal advertising servers (FIG. 29) and store servers (FIG. 28) the users register with just one portal web server and see aggregated deals from all in a graphical display with mapping information. The portal web site operates with or without user location information. If users block location tracking or do not provide location information the map will not display their position and will not move as they move around. Instead, the user navigates the map manually by providing location information, or scrolling and zooming the map.

B. Deal-Server Centric Approach

In a deal-server centric approach, the buyer selects the quantity of the desired item if applicable and expresses interest in purchasing the deal. The deal advertising server checks to determine if the deal conditions are met. Deal conditions include if a minimum required number of buyers have expressed interest, if the item is still available, and/or if the potential buyer qualifies for the deal (e.g., minimum age requirement).

If the deal conditions are met then the deal advertising server uses the associated transaction server 185 to charge the buyer (e.g., Paypal™, credit/debit card, rewards points, etc.) and credits the store in exchange for a transaction fee (if multiple stores are involved it credits separate amounts to each store). The deal server sends an electronic receipt to the mobile device of the buyer. The buyer then visits the store, shows the electronic receipt, and receives the item. The buyer may also request shipment of the item to a shipping address and not even visit the store.

C. Store Centric Approach

In a store-centric approach, the deal server advertises the deal and the buyer uses the store's transaction system to purchase the deal item(s). The store in return pays a flat-rate or volume-based fee to the deal server company for the deal service (in a multi-store deal each store pays a separate fee to the deal server). For example, in a store centric approach if the user clicks the “Purchase” button 360 shown in FIG. 3 the browser connects to the store's server and uses the store's transaction server. This is implemented with the deal advertising server transferring the user's authentication information to the store's server in some embodiments. In other embodiments, the store server requires the user to re-login to the store server in order to perform the transaction.

In other alternative embodiments, the user calls the store to purchase the item. This call is achieved, e.g., with a regular phone call, or a link on the web page in FIG. 3 to connect to a VoIP server and dial the store's number. For instance, the purchase button or a link in the store's information page in some embodiments has the parameters for the store's phone number and the VoIP server. The user may also visit the store to check the product and purchase the item at the store using the store's transaction system. The advertisement interface also has a mechanism (such as a button, link, comment field, VoIP Call, etc.) for the user to notify the store of his/her intentions to visit the store in some embodiments.

### III. Deal Referral and Reward Sharing

Some embodiments allow a registered user of the deal advertising server to refer deals to other users with or without purchasing the deals. In FIG. 3, registered member U1 (Dave King) does purchase the deal by specifying the quantity and clicking the “Purchase” button 360. He then decides to forward the deal to others to get referral rewards; in effect making him a selling agent that gets a commission. The referral reward is separate from any rewards the buyer may receive from the advertising server or the store for purchasing the deal.

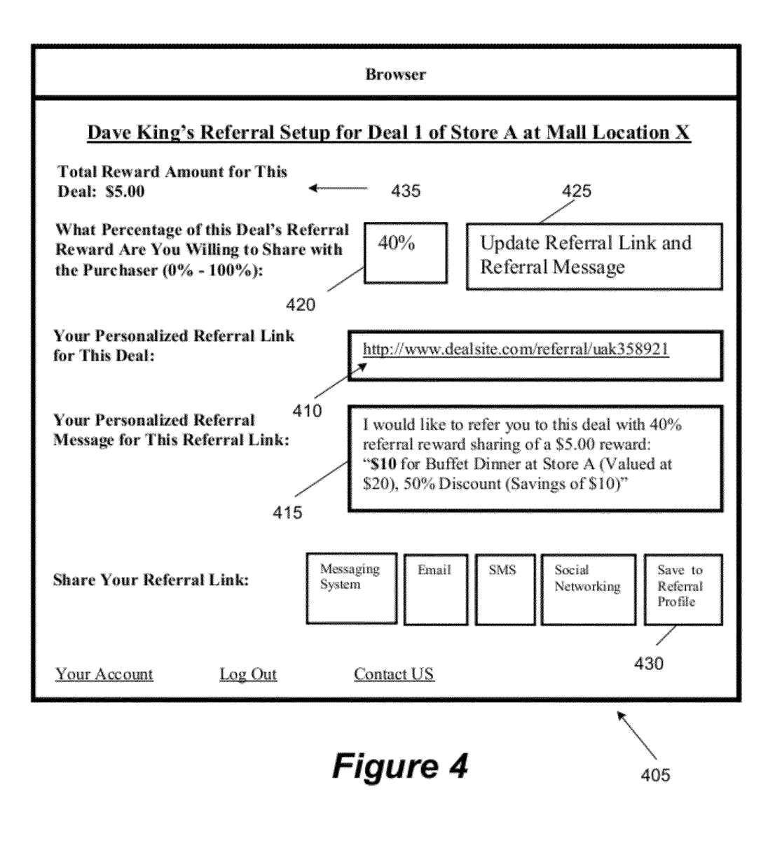

FIG. 4 conceptually illustrates the interface after the user in FIG. 3 clicks on the “Refer a Friend and Get Rewards” link 320 for Deal 1 of store A in some embodiments of the invention. The referral page 405 is an example of a page that allows the member to specify a reward sharing parameter that specifies how much of the referral rewards he/she is willing to share with the person they refer the deal to. By default this reward sharing parameter is zero, which is a special case and is the current state of the art. Specifying a non-zero number, however, gives added incentives for the person receiving the referral message to purchase the deal since they will receive a discount from store A and an additional discount from the referral commission.

The referral page 405 displays (as shown by arrow 435) the total amount of the reward for the current deal. In some embodiments the referral reward is a monetary amount (e.g., $5 in FIG. 4), while in other embodiments the referral reward is other type of rewards such as points in a point system, where points are accumulated towards purchasing items and getting cash rewards. The referral page 405 provides a unique personalized referral link 410 for the referring member. The referral page also has a “Personalized Referral Message” 415 that has textual information about the deal and includes the reward sharing parameter. This message and the referral link are deal attributes that are used to advertise the deal to nearby shoppers. The referral link has name/value pairs for the referring member ID, the deal ID, the reward sharing parameter, and other parameters of interest (uak358921 shown in the referral link 410 is an example of a shortened link that is decoded by the server to extract these parameters and show them; in other embodiments, these parameters are directly included in the link).

The reward sharing parameter 420 is specified as a percentage in some embodiments. For instance, a value of 40% for the reward sharing parameters means that if there is a $5 referral reward then $3 is awarded to the referring member (Dave King) and $2 is awarded to the buyer. In this example if the deal states that the buyer also gets a purchasing reward from the advertising server or the store of $1, then the buyer gets a total reward of $3 ($2 from referral reward sharing, and $1 from purchasing). Although this example used cash to demonstrate the process, many stores and servers offer reward points for future purchases instead of cash back. The referring parameter is input as a percentage with error checking, a pull down menu, or other input methods in some embodiments. The referring parameter may also be absolute values (e.g., 4 reward points) instead of percentages.

When the member updates the referral link by pressing the “Update Referral Link and Referral Message” button 425 the deal server uses a URL link shortener program to create a unique short URL alias for the long URL that has the name value pairs. The deal server also updates the referral reward sharing percentage number in the personalized referral message 415. The member can then share the personalized referral link and message with other users by conventional server-based communication methods (email, text or instant message, social networking, deal server's messaging system and/or portal web site). For example, Dave King can use the access point or the cell towers of FIG. 1 to connect to the network and send this link to his friends; U20 104 and N20 120.

In some embodiments, the “Update Referral Link and Referral Message” button 425 in FIG. 4 is replaced with “Create New Referral Link” so previous referral links with different reward sharing parameters will be stored for later use. The member then uses these pre-stored links or changes the reward sharing parameter as needed prior to referral so that different people get different reward sharing percentages. For example, Dave King sends one referral link to his good friend U20 with 40% reward sharing and sends another referral link to distant friend N20 with 20% reward sharing.

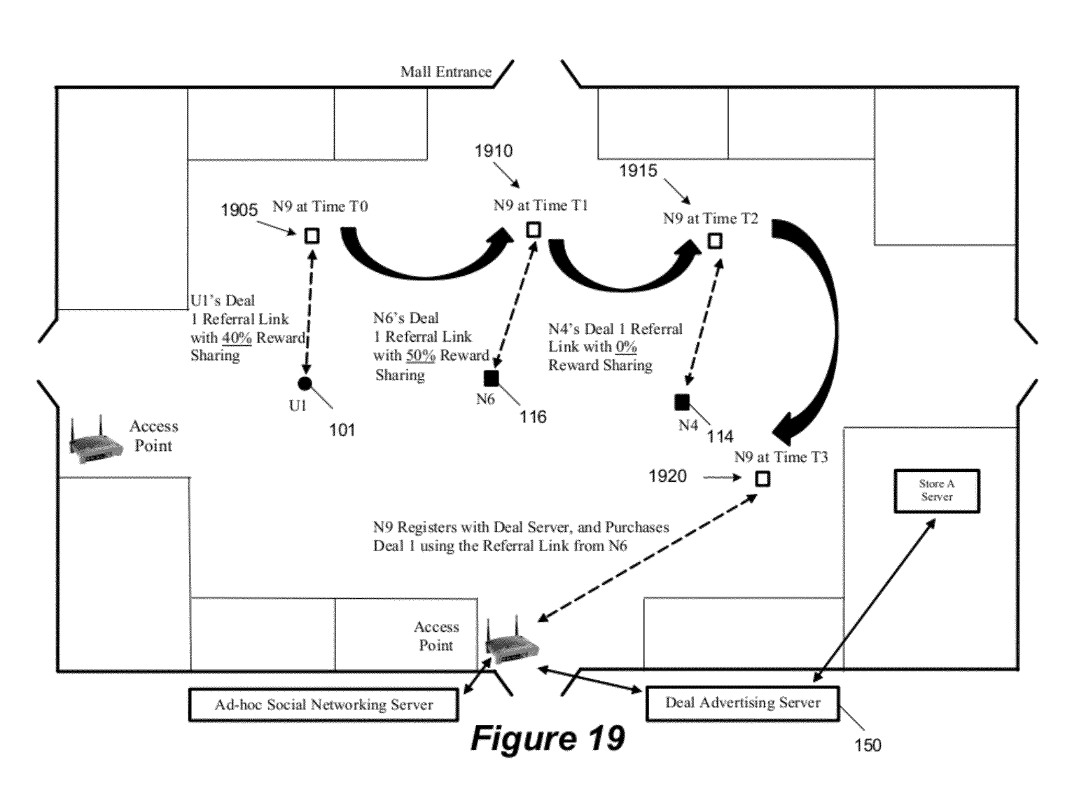

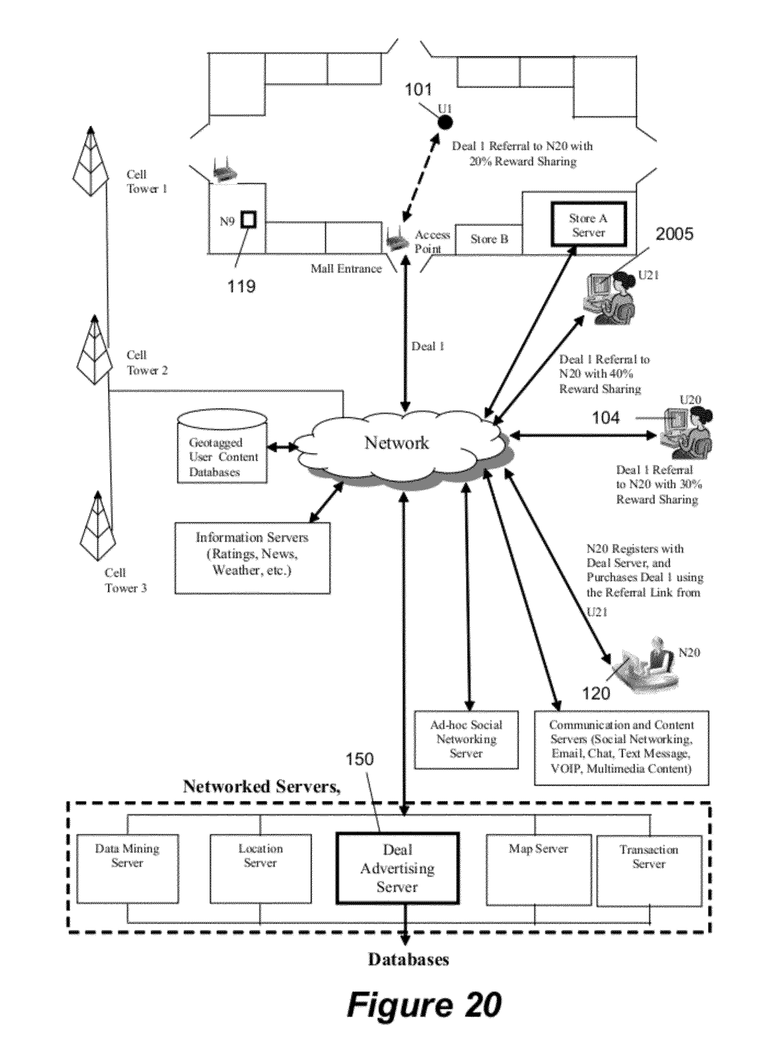

Users who receive the referrals may also obtain multiple referral links from different members in which case they can use the referral link that gives them the most favorable reward sharing treatment (as described by reference to FIGS. 19 and 20, below). FIG. 4 also shows the member has the option for “Save to Referral Profile” 430. This is one example of how a member can add the personalized referral information to his/her profile. This referral profile (as described by reference to FIG. 9, below) is then used by an ad-hoc social networking application to send the referral link to the mobile devices of nearby users (as described by reference to FIG. 8, below).

In some embodiments, users who receive a referral deal from one or more other users negotiate with (by sending counter coffers to) the offering users to get a better share of the referral rewards. In these embodiments, interface 405 (such as the messaging system in FIG. 4) displays the counter offers to an offering user and allows the offering user to compose a revised message with a revised reward sharing offer if the offering user wishes to negotiate the referral reward.

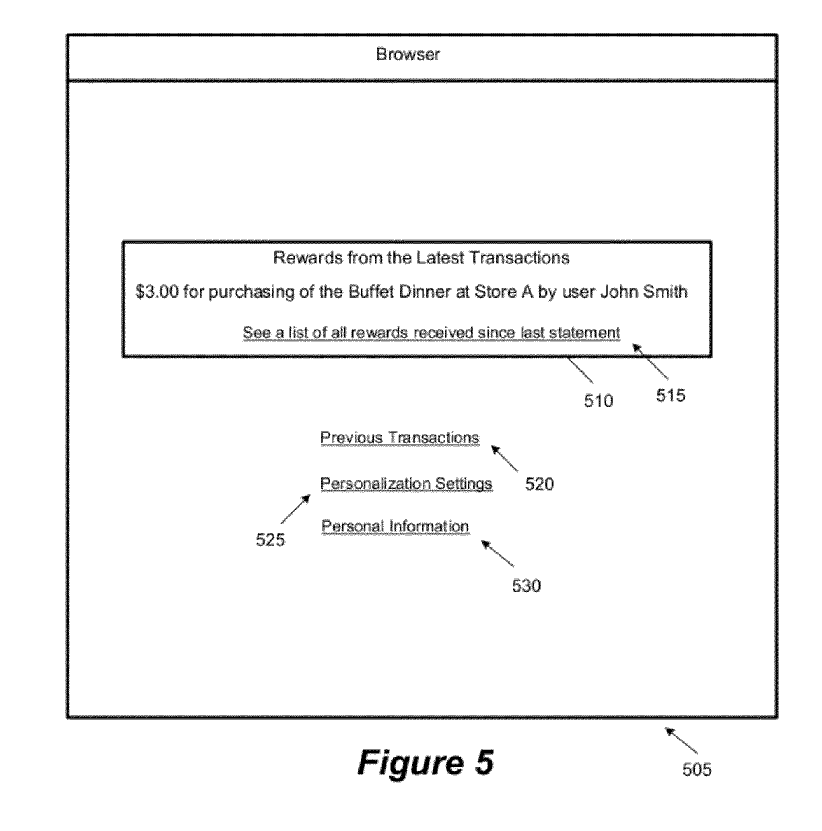

FIG. 5 conceptually illustrates an interface 505 for displaying user account information after the user in FIG. 3 clicks on the “Your Account” link 345 in some embodiments of the invention. As shown, the reward received by the user in the last reward sharing transaction is shown in display area 510. In this example, the user has received $3.00 when another user, John Smith, has purchased the deal for buffet dinner at Store A which was referred by the user.

The user is also provided by a link 515 for displaying a list of all rewards received since the last statement. In other embodiments, the user is provided by links to display rewards received in different periods of time (e.g., in each of previous months). The user is also provided by a link 520 for displaying previous transactions, a link 525 for viewing and changing personalized settings, and a link 530 for viewing and changing the user's personal information.

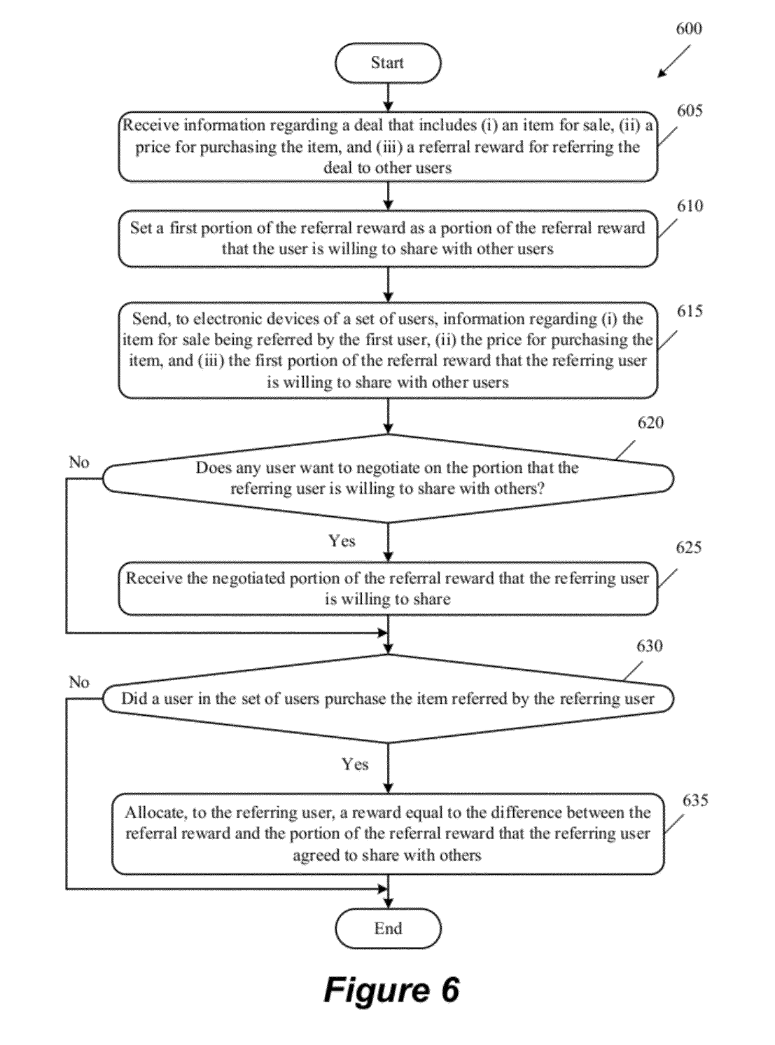

FIG. 6 conceptually illustrates a process 600 for deal referral and reward sharing in some embodiments of the invention. As shown, the process receives (at 605) information regarding a deal that includes (i) an item for sale, (ii) a price for purchasing the item, and (iii) a referral reward for referring the deal to other users. The information is received either as a message that includes the information or as a shopping profile of another user which includes items to sell. The process then sets (at 610) a portion of the referral reward as a portion of the referral reward that the user is willing to share with other users. This portion is either set when the user reviews the deal and sets the portion that the user is willing to share or the user has set a set of criteria that the process uses to automatically set the portion that the user is willing to share with the others. When the user is willing to share a portion of the rewards with others, the portion is non-zero (e.g., $1.00, 30%, 5 points, etc.)

The process then sends (at 615) information regarding (i) the item for sale as an item that is being referred by the user, (ii) the prices for purchasing the item, and (iii) the portion of the referral reward that the user is willing to share with other users. The process then determines (at 620) whether any user wants to negotiate on the portion that the referring user is willing to share with others. In some embodiments, a user who receives an offer is provided with the option to negotiate with the offering user to get a larger portion of the referral reward. Also, in some embodiments, users receive multiple offers for the same item from different users. In these embodiments, the user that has received multiple offers, can select the most favorable offer. The user that has received multiple offers is also provided with the option to negotiate for a different portion of the referral reward with one or more of the offering users. In some embodiments, the negotiations are done automatically by the process on one or both users' electronic device based on criteria that are set by each user.

The process then receives (at 625) the negotiated portion of the referral reward that the referring user is willing to share. The process then determines (at 630) whether a user that has received the offer has purchased the item that was referred by the referring user. The process then allocates (at 635) a reward equal to the difference between the referral reward and the portion of the referral reward that the referring user agreed to share with others. The process then ends. In some embodiments, the reward is allocated by a deal advertising server which receives and processes the purchase request and allocates the referral reward. In these embodiments, process 600 receives (at 635) an indication or a confirmation for the reward allocated to the referring user. The buying user also receives a confirmation of the purchase and the amount of the referral reward that the buying user receives.

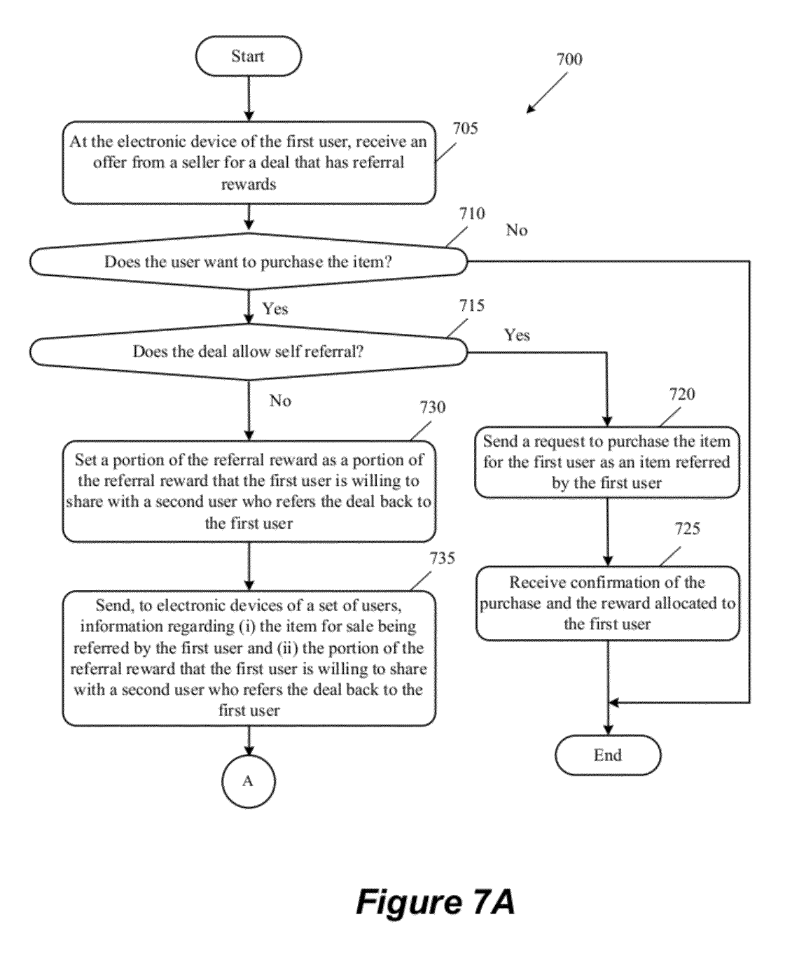

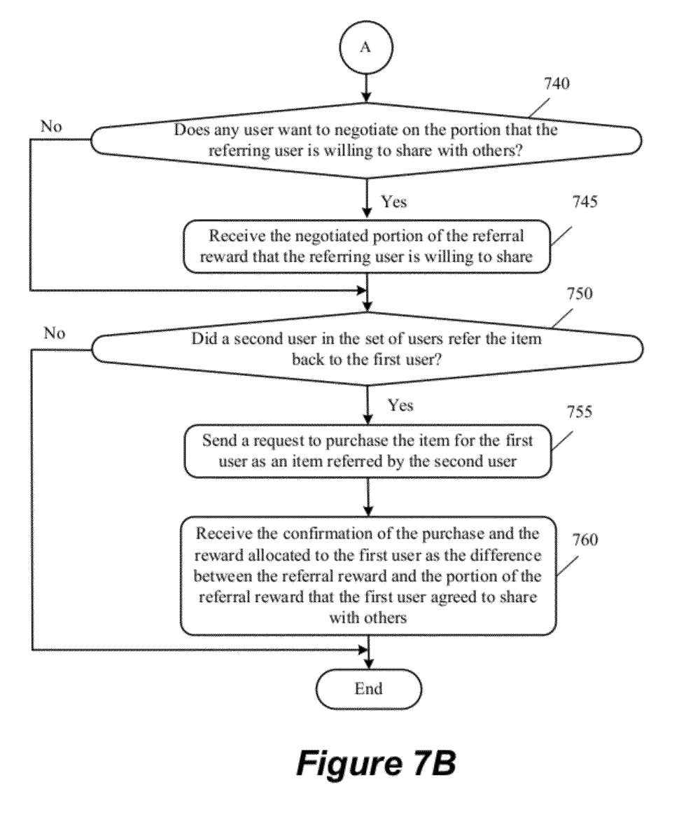

Some embodiments provide indirect self-referral for deals that are offered by sellers/users who do not offer referral rewards to users that directly purchase a deal from them but do offer referral rewards to users that refer the deal to others. The user in some embodiments of the invention, however, is provided with the option to find someone else to refer him/her to the deal and share the referral rewards with. FIG. 7 conceptually illustrates a process 700 for providing indirect self-referral in some embodiments of the invention. As shown, the process at the electronic device of a first user receives (at 705) an offer for a deal that has referral rewards. The offer, e.g., comes from either a merchant who has a product/service to sell or the offer comes from another user who is referring the deal (e.g., by sending a message or sending a shopping profile) and is willing to share the rewards with other referring users (i.e., the users who receive the offer and send the offer to other users) but not with a user who purchases the deal. The process determines (at 710) whether the first user wants to purchase the deal. The determination of whether the user wants to purchase the item is either done automatically or after alerting the first user and receiving an approval for the purchase. In some embodiments, the process uses keyword matching or semantics-based matching to determine from the shopping profile of the first user whether the first user is interested in the deal. Keyword matching and semantics-based matching methods used in some embodiments are described further below. If the user is not interested to purchase the deal, the process exits. In some embodiments, whether or not the first user is interested in purchasing the deal, process 600 which was described by reference to FIG. 6 is utilized to determine whether the user wants to use deal referral and reward sharing for any item of common interest.

When the first user is interested in purchasing the deal and collecting referral rewards, the process determines (at 715) whether the deal allows for the purchaser to collect rewards for self-referral. If so, the process sends a request to purchase the item for the first user as an item referred by the first user. The process then receives (at 725) confirmation of the purchase and the reward allocated to the first user. The process then exits.

Otherwise, when the deal does not allow self-referral, the process sets (at 730) a portion of the reward referral (e.g., a non-zero amount or non-zero percentage of the reward) as a portion of the referral reward that the first user is willing to share with a second user who refers the deal back to the first user. The process then sends to electronic devices of a group of users (at 735) the item for sale and the portion of the referral reward that the first user is willing to share with a second user who refers the deal back to the first user. Some embodiments utilize a process that is a combination of processes 600 and 700 such that the first user sends the information for self-referral as well as the information for referring the deal to others to be purchased by others (e.g., by sending a combination of the information in operation 735 and 615). However, for simplicity, processes 600 and 700 are described separately.

The process then determines (at 740) whether any user wants to negotiate on the portion that the first user is willing to share with others (e.g., the process receives a message from the electronic device of a referred user that the referred user wants to negotiate to get a larger portion of the referral fee from the referring user). If no, the process proceeds to 750 which is described below. Otherwise, the process receives (at 745) the negotiated portion of the referral reward that the referring user is willing to share.

The process then determines (at 750) whether a second user in the set of users has referred back the deal to the first user. If no, the process exits (e.g., after a pre-determined time elapses or a deadline associated with the deal expires). Otherwise, the process sends (at 755) a request to purchase the item for the first user as an item referred by the second user. The process then receives (at 760) the confirmation of the purchase and the reward allocated to the first user as the difference between the referral reward and the portion of the referral reward that the first user agreed to share with others. The second user also collects a referral reward equal to the portion of the referral reward that the first user agreed to share. The process then exits. Although self-referral is described as a separate process, process 700 is used by other processes (e.g., in P2P and multi-hop embodiments described below) whenever referral fees are involved, a user wants to purchase the deal for himself/herself, and the deal does not allow referral fees for the purchaser.

### IV. Ad-Hoc Social Networking Between Shoppers

A member making a referral acts as a seller advertising a product to a buyer in some embodiments. FIG. 8 conceptually illustrates two mobile devices using ad-hoc networking and profile matching to share shopping deals and rewards in some embodiments of the invention. As discussed above, a user referred to herein as a seller can be a user or entity that has a merchandize or a service to sell or the user might be a user that is referring a merchandize or service sold by another user (or a merchant, company, web site, etc.) and is attempting to collect referral fees and share the rewards. FIG. 8 shows a seller using his/her mobile device 805 to communicate with the mobile device 810 of a buyer in order to sell products in some embodiments. The two mobile devices can be different types of devices but both have ad-hoc networking and routing control capabilities and the same ad-hoc social networking application installed and running (or compatible ad-hoc social networking applications that can communicate with one another).

As shown, each mobile device includes several components or modules 850-890. The seller and the buyer have previously downloaded the ad-hoc social networking application 860 or equivalent browser code/plug-in from the ad-hoc social networking server 160 (shown in FIG. 1). For instance, some embodiments allow the users to download the application from an access point or kiosk inside the mall, if they have not installed the application previously from home, work, the mall, or other locations. So while a buyer may not be a registered member of the deal advertising server she can communicate her shopping interests to a member seller. The ad-hoc social networking application 860 together with the ad-hoc networking and routing control module 890 allow mobile devices to communicate directly with other nearby mobile devices without using an infrastructure access point (e.g., without using a short range access point such as a Wi-Fi access point or a cellular base station). This is useful where an access point is not available, the mobile device does not have a data plan, or the user does not want to use his data plan for cost reasons.

The social networking application 860 uses a profile management utility 850 for creating and updating the profiles of sellers and buyers. The social networking application 860 also uses a profile matching component 855 which establishes a match between the profile of a seller and the profile of a buyer. For instance, the seller has an item to sell and the buyer has a history of buying or referring the same or similar items or has the same or similar items in a wish-list or shopping list. In some embodiments a seller device 805 transmits the seller profile to a buyer, the buyer's profile matcher 855 establishes a match with the buyer's profile and alerts the buyer about the match via a method such as email, text message, voice message, or a sound alert. The buyer then initiates contacts. For example, the buyer then uses a separate wireless channel to connect to an access point 820 (Wi-Fi, cellular) and information servers 830 to see reviews of the seller and the offered products (also search social networks to get other profiles of the seller), or use an access point to connect to server 1 825 and purchase the advertised deal, or use the P2P wireless connection to communicate with the seller (e.g., chat session, VoIP session) and/or purchase from him directly. Although profile matcher 855 is shown in FIG. 8 as a separate module, the profile matcher is a module of the ad-hoc social networking application 860 in some embodiments.

In some embodiments, the reverse happens where a buyer transmits her buyer's profile to a seller, the seller's profile matcher 855 establishes a match with the seller's profile and alerts the seller, and the seller contacts the buyer. In some embodiments a user is both a seller that is transmitting a selling profile and a buyer that is transmitting a buying profile. A seller can be proactive by transmitting his selling profile or reactive by listening to (or monitoring) received shopping profiles and computing matches. Likewise, a buyer can be proactive by transmitting her shopping profile or reactive by listening to received selling profiles and computing matches. In some embodiments, a first user's mobile device requests the profile of a second user, receives the profile of the second user on his mobile device, and performs matching/alerts. In some embodiments a first user's mobile device requests the profile of a second user, receives a brief profile of the second user on his mobile device, and performs matching/alerts.

In some embodiments a first user and a second user gradually reveal information to each other about their profiles by first broadcasting (or requesting) a summary profile and then incrementally revealing more information by sending profile increments that contain more information. This is more analogous to human social interaction. For instance, a first user utilizes the social networking application on his/her electronic device and broadcasts or sends a summary (initial, abridged, or first) profile indicating the user has a camera and is interested in purchasing photographic equipment. The electronic device of another user receives the profile of the first user and determines that there is a match between photographic equipment item in the first user profile with items (e.g., tripods) in the profile of the second user. Second user then sends a more detailed profile indicating that the user is interested in selling tripods. The first user then requests and receives a more detailed profile from the second user that itemizes e.g., the brand name and prices of the tripods. The users, therefore, gradually reveal more information to each other about their profiles once a match is found. In some embodiments, a user sends a more detailed profile after the two users communicated through chat, email, voice, etc.

The ad-hoc social networking application asks first time users to enter some information, such as a user ID name that does not have to be a real name, an email address, and a password. Users then form their locally stored profile or profiles in some embodiments by inputting some keywords or choosing from some pre-existing menus and checkboxes. In a shopping scenario the seller has a profile that provides information about the products he is selling, and the buyer has a profile about products she wants to buy. As shown in FIG. 8, each user's device includes web server 880, web browser 895, memory/storage 885, and ad-hoc networking and routing control 890 modules. In addition to modules 850-890, each user's device also includes modules for sending messages, receiving messages, displaying information on the mobile device display, generating sound alters, receiving user inputs, etc., which are not shown in the figure.

FIG. 9 conceptually illustrates an example of a deal referral profile in some embodiments of the invention. For example, the seller has a profile 905 such as that shown in FIG. 9. This profile provides information about advertised deals and coupons on a web server and includes the seller's personalized referral reward sharing parameters (the details of each profile are not shown in the higher level interface shown in FIG. 9). The profile is transferred using the interface in FIG. 4, emailed, or transferred from another computer with a storage device in some embodiments.

Likewise, the buyer has a shopping profile that includes shopping categories and shopping lists of interest. FIG. 10 conceptually illustrates an example of a shopping profile 1005 in some embodiments of the invention. The profile matcher uses simple keyword matching, or more complex semantic-based matching that uses ontologies to match different but related keywords. The use of semantics matching and ontologies provide inference of similarities between two profiles that use different vocabularies. For example, the profile matcher infers that a user with a shopping profile that has “digital camera” in her shopping list or wish-list is also going to be interested in “digital camera accessories” such as memory, lens, case, flash, tripod, etc., and can match discount deals for camera accessories with her profile.

Self-referral is a scenario where a shopper finds a deal of interest that has a referral reward but the deal does not allow the person to refer himself and get the referral rewards. The shopper in some embodiments of the invention, however, can use the P2P wireless communication with nearby users to find someone to refer him to the deal and share the referral rewards with. In some embodiments, the shopper can also use a conventional network to find someone to refer him to the deal and share the referral rewards with. For instance, when there is a location-based centralized server that tracks users and if users can use a cellular data network or Wi-Fi network to reach that server they could use that service for self-referral or finding other interested buyers to share their purchases. The use of the P2P network is advantageous if a Wi-Fi or cellular network is not available. Also, a P2P connection such as a Bluetooth® connection to a nearby user may require less power than Wi-Fi or cellular systems. Furthermore, the users may not want a centralized server to track their location and the use of P2P network enables the users to communicate with other nearby users without being tracked by a centralized server.

Another scenario is where a user receives a coupon on his mobile device. This can be directly from a store server, from a deal advertising server, or from another mobile device that is acting as a network node. The coupon requires a minimum number of buyers, but not enough buyers have signed up for the deal. This user is interested in the deal and uses ad-hoc networking to find other shoppers to sign up for the deal so that he can use the coupon too.

Users in some embodiments make other profiles for different ad-hoc social networking scenarios and use those profiles instead or in combination with the shopping profile. For instance, a gaming profile can be used in some embodiments to find nearby people to play online video games, a career profile can be used to find jobs, and a dating profile can be used to find a romantic relationship. Users can also share different profiles at different locations. For example, they can share their shopping profile at a mall, their career profile at a job fair, and dating profile at a night club.

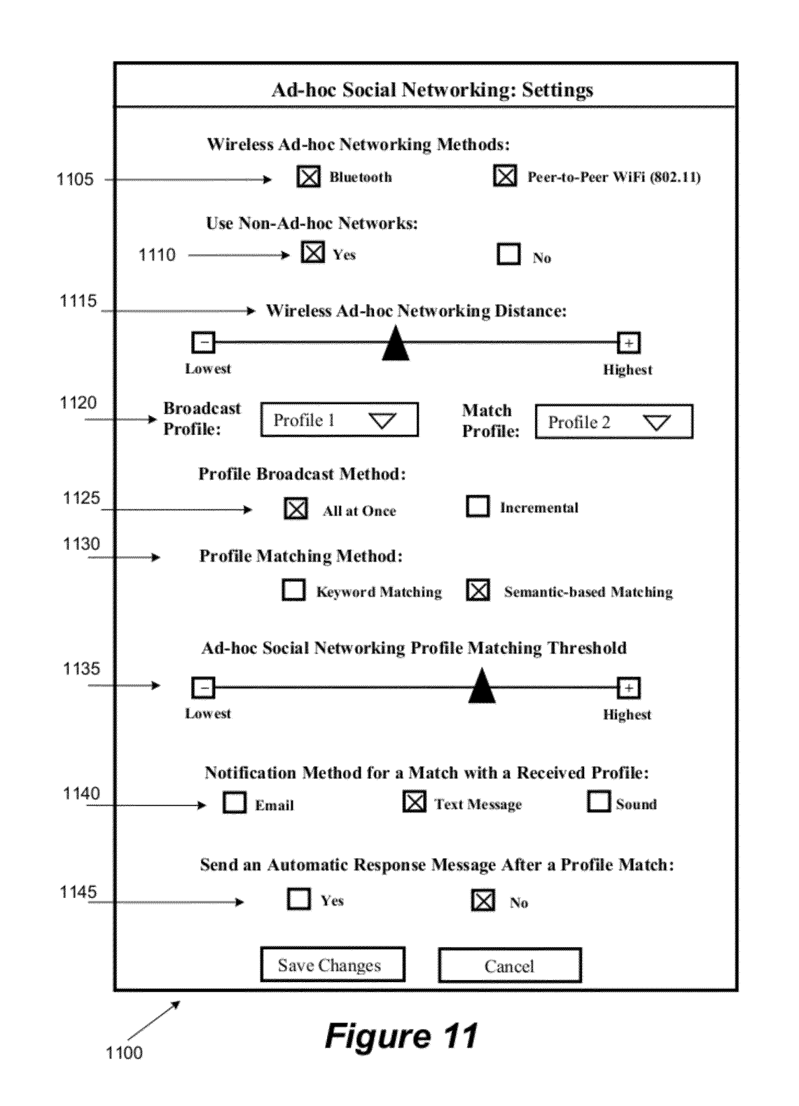

FIG. 11 conceptually illustrates an example of settings for the ad-hoc social networking application in some embodiments of the invention. The ad-hoc social networking application has settings that are adjustable by sellers and buyers, as shown in graphical user interface (GUI) 1100 of FIG. 11. The user chooses (as shown by arrow 1105) the P2P communication methods (e.g., Bluetooth®, Wi-Fi, NFC, RFID, WiMax, etc.). The user chooses (as shown by arrow 1110) whether he/she also wants to use non ad-hoc networks by connecting to access points. For example, in FIG. 8 the seller can use a separate communication channel to connect to an access point (e.g., Wi-Fi or cellular) and communicate with server 1, download data, and then make a sale or a referral to the buyer. The buyer can also use a separate communication channel to connect to information and communication servers and check the credentials of the seller and his products before contacting him and/or making a transaction. The transaction can occur between the buyer and server 1 of FIG. 8 over a second communication channel using an access point, or between the buyer and seller using the P2P wireless link. Users can adjust (as shown by arrow 1115 in FIG. 11) P2P wireless settings to specify the maximum communication distance. This can be accomplished by changing the transmit power of the radios.

The GUI also allows the users to choose which profile or set of profiles they would like to broadcast to other nearby users (e.g., shopping, job search, dating, etc.). A user can also choose (as shown by arrow 1120) the same transmit profile or a different profile to be used to match to received profiles. For example, a user can broadcast and advertise deals but for matching with received profiles it can use a different profile that includes the deals but also includes dating (so only he would know of a dating match since he is not broadcasting his dating profile but receiving dating profiles from others). Another example is when a buyer broadcasts a shopping list with a lower price but uses a second profile for matching with received profiles (of sellers) that has a higher price. So if his broadcast message does not find a match for the lower price his receive matching profile might find a match with the higher price.

A user can choose (as shown by arrow 1125) to send the profile all at once, or to transmit a summary profile and follow-up with profile increments in case a match is found. Another setting (as shown by arrow 1130) allows the user to choose the profile matching method (e.g., keywords, semantic-based). The profile matcher uses a threshold setting to alert the user of a match. Users can adjust (as shown by arrow 1135) this threshold in order to receive fewer or more matches and alerts. Users can also choose (as shown by arrow 1140) how they should be alerted once a profile match has been found, and (as shown by arrow 1145) whether an automatic response message should be sent to the mobile device of the other user that has the matched profile.

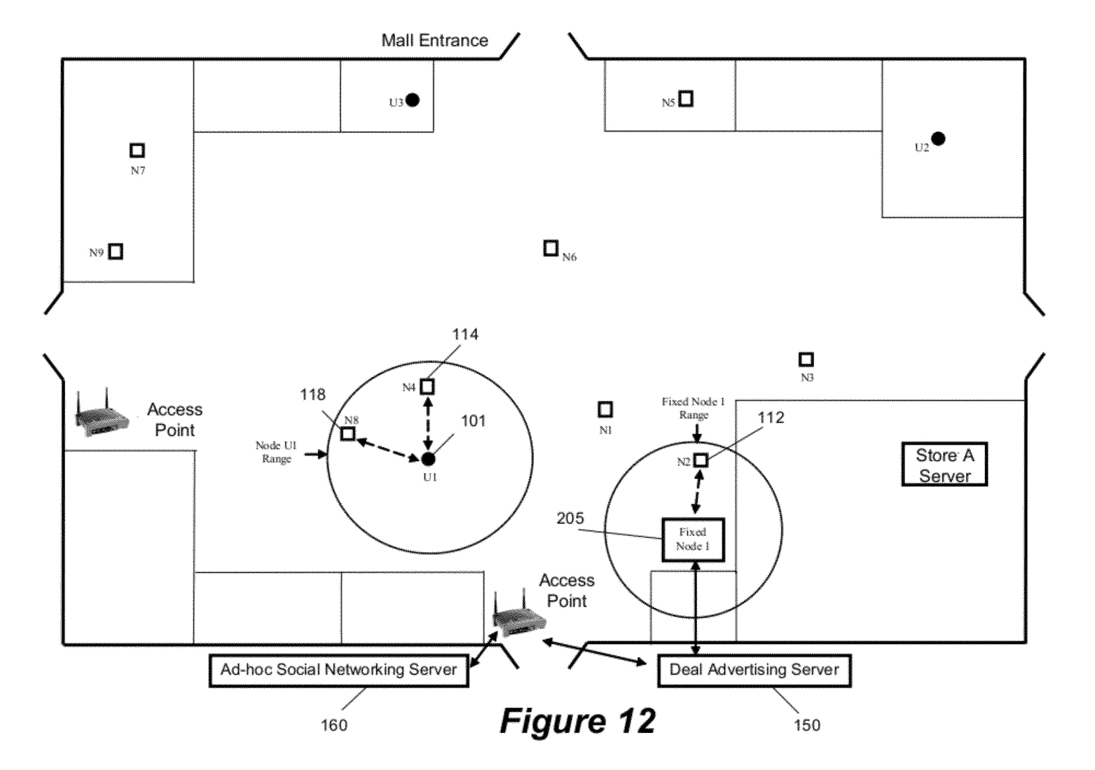

FIG. 12 conceptually illustrates the position of shoppers of FIG. 2 at a later time instance, where a user uses his mobile device and an ad-hoc social networking application to advertise a deal to nearby unregistered users. FIG. 12 shows the mall view of FIG. 2 at a later time instance. Here user U1 101 uses his mobile's ad-hoc social networking application and broadcasts his referral profile (as described above by reference to FIG. 9) to the mobile devices of non-member users N4 114 and N8 118 which are now within transmission range.

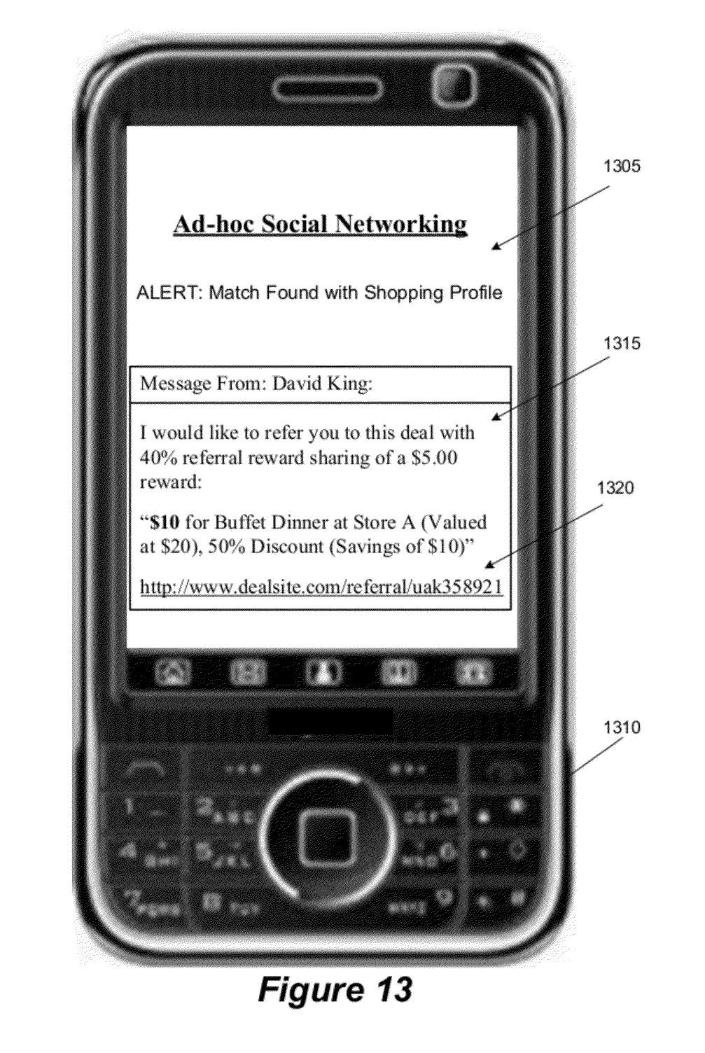

Fixed node 1 205 also broadcasts deal 1 to the mobile device of non-member user N2 112. The profile matcher of user N4's mobile device finds a high correlation between the shopping profile of N4 (as shown in FIG. 10 which includes “Restaurants” 1010) and referral profile of U1 101 that includes “buffet dinner” information 415 about deal 1 (as shown in FIG. 4). FIG. 13 conceptually illustrates an example of an alert message on the mobile device 1310 of a potential buyer indicating a match between his shopping profile and the referral profile of a nearby user in some embodiments of the invention. The profile matcher alerts user N4 114 with an alert message such as that shown in FIG. 13. The alert message 1305 includes the user ID name of user U1 101 and the attributes of deal 1 that are in the profile of user U1 101, such as user U1's personalized message 1315 and referral link 1320. In this example, user N4 114 is interested to find out more about the advertisement so she clicks on the referral link. Her browser (or application) then makes a network connection to get to the deal advertising server (using Wi-Fi, cellular, WiMax, or P2P networking using one or more mobile devices acting as network nodes to get to an access point or a cellular base station that can network with deal advertising server 150).

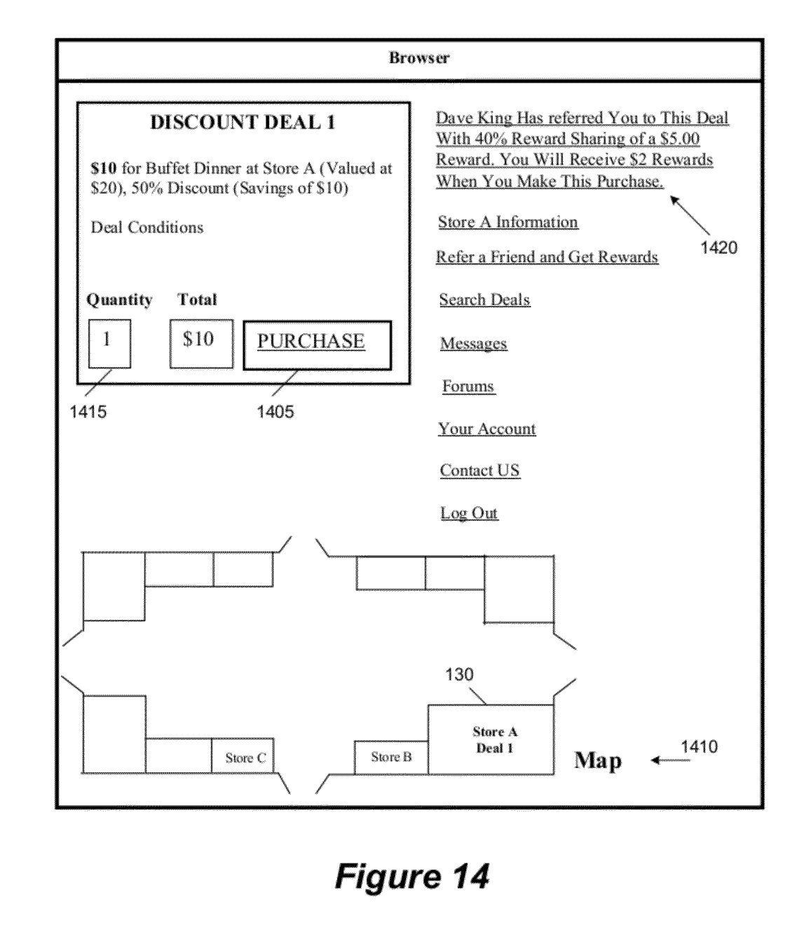

The deal advertising server 150 receives the URL link request, uses the link shortener to look up the long URL, decodes the encoded parameters of the URL, and transmits back information that is displayed on N4's mobile browser. FIG. 14 conceptually illustrates the information that is displayed on the non-member user N4 114 mobile device's browser or an installed application. Since user N4 114 is not a registered tracked member the map 1410 only shows the location 130 of deal 1.

In this example, the referral rewards for this deal is $5. Since user U1 101 specified 40% reward sharing in his referral link, FIG. 14 indicates that user N4 114 will receive $2 shared rewards if she purchases this deal (as shown by arrow 1420). User N4 114 decides to purchase this deal by specifying the quantity 1415 and clicking the “Purchase” button 1405. The deal advertising server 150 (shown in FIG. 1) then asks her to register and setup an account with payment information. User N4 114 completes the registration process and becomes a member. She then confirms the purchase which results in a transaction server debiting her account for the purchase. The transaction server also credits the reward amounts to the accounts of the referrer and the purchaser ($3 for user U1 101 and $2 for user N4 114). In FIG. 12 user N2 112 also registers and purchases deal 1. User N8 118 however ignores the advertisement either because there is no match with his profile and he does not get an alert, or because he decides to ignore the match. Both users N4 114 and N2 112 obtain their own personalized referral links and messages for deal 1, and add deal 1 attributes to their social ad-hoc networking transmit profiles.

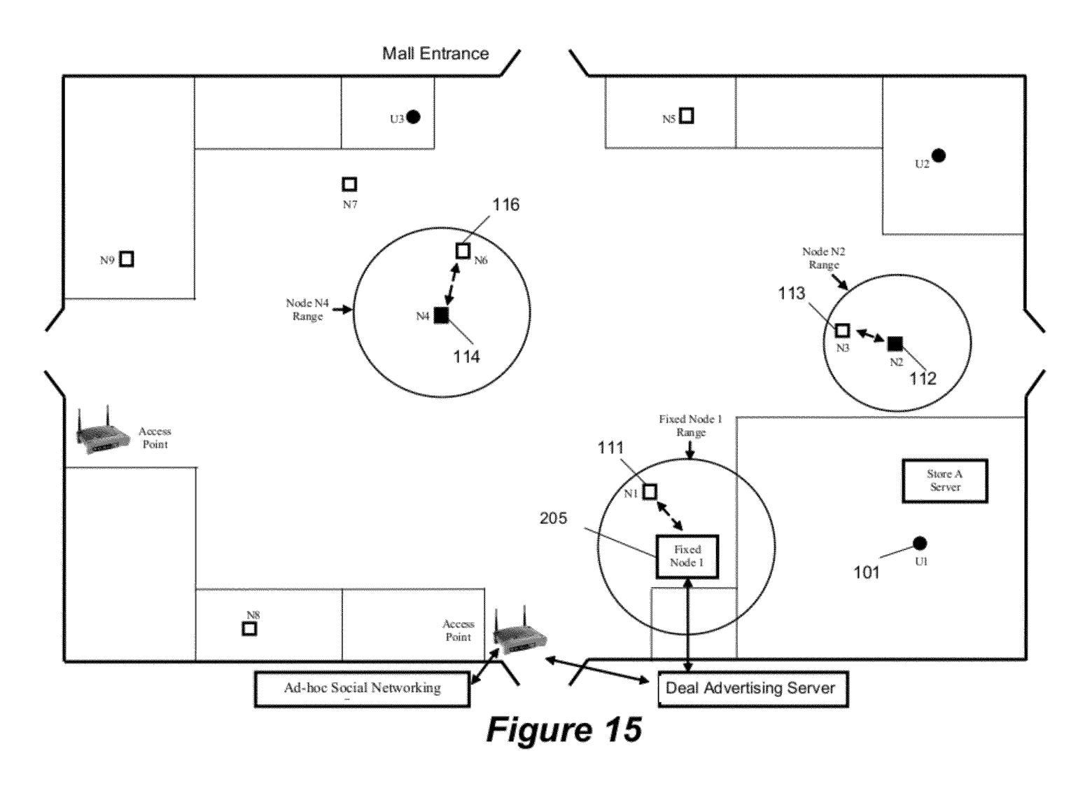

FIG. 15 conceptually illustrates the position of the shoppers of FIGS. 1, 2, and 12 at a later time instance and demonstrates further advertisement of the deal with ad-hoc networking. User U1 101 has gone to the store to redeem the dinner he purchased. Newly joined members N2 112 and N4 114 are shown as black filled squares in FIG. 15 to signify that they are now registered members of the deal advertising server. In this figure fixed node 1 205 forwards the deal to user N1 111, user N2 112 forwards the deal to user N3 113 with his own personalized referral link, and user N4 114 forwards the deal to user N6 116 with her own personal referral link. Non-member users N1 111 and N3 113 register with the deal advertising server and purchase the deal. User N6 116 also registers with the deal advertising server but does not purchase the deal. Instead user N6 116 obtains his/her own personalized referral link and message. His intention is to refer the deal to others and get rewards to purchase something else.

Different embodiments for multiple offers, negotiation between the users, sharing of the rewards, self-referral, etc., that are discussed throughout this Specification apply to P2P networks and are not repeated for brevity.

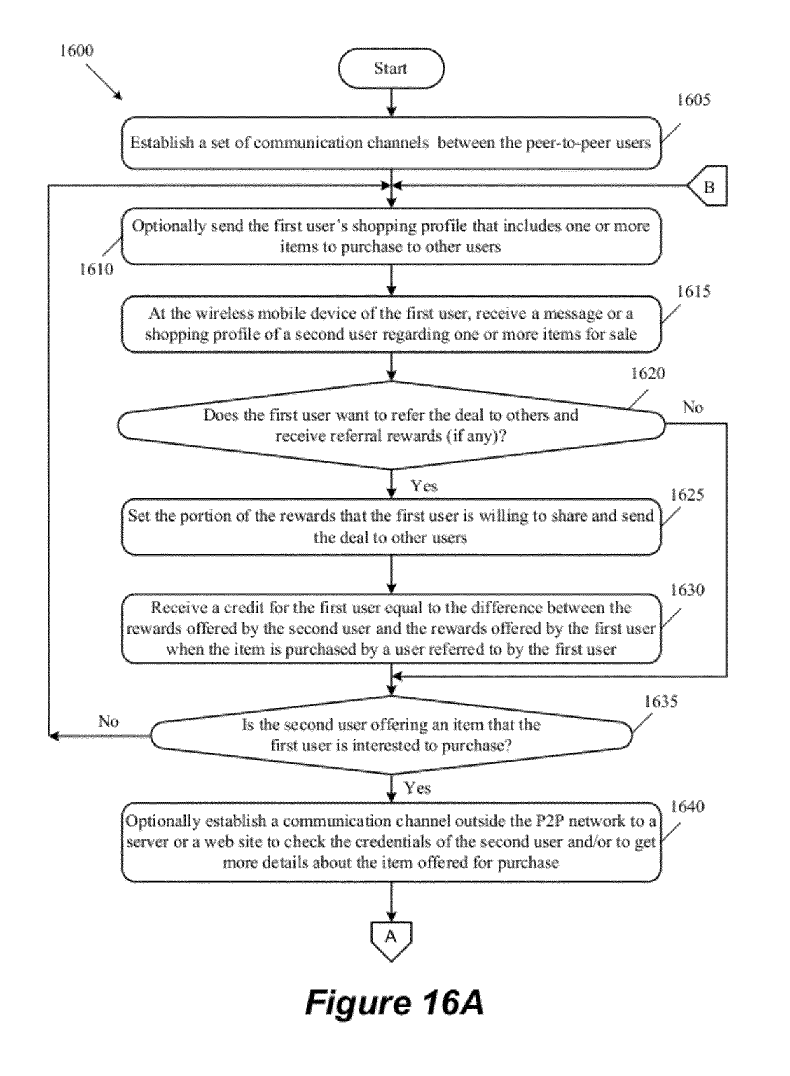

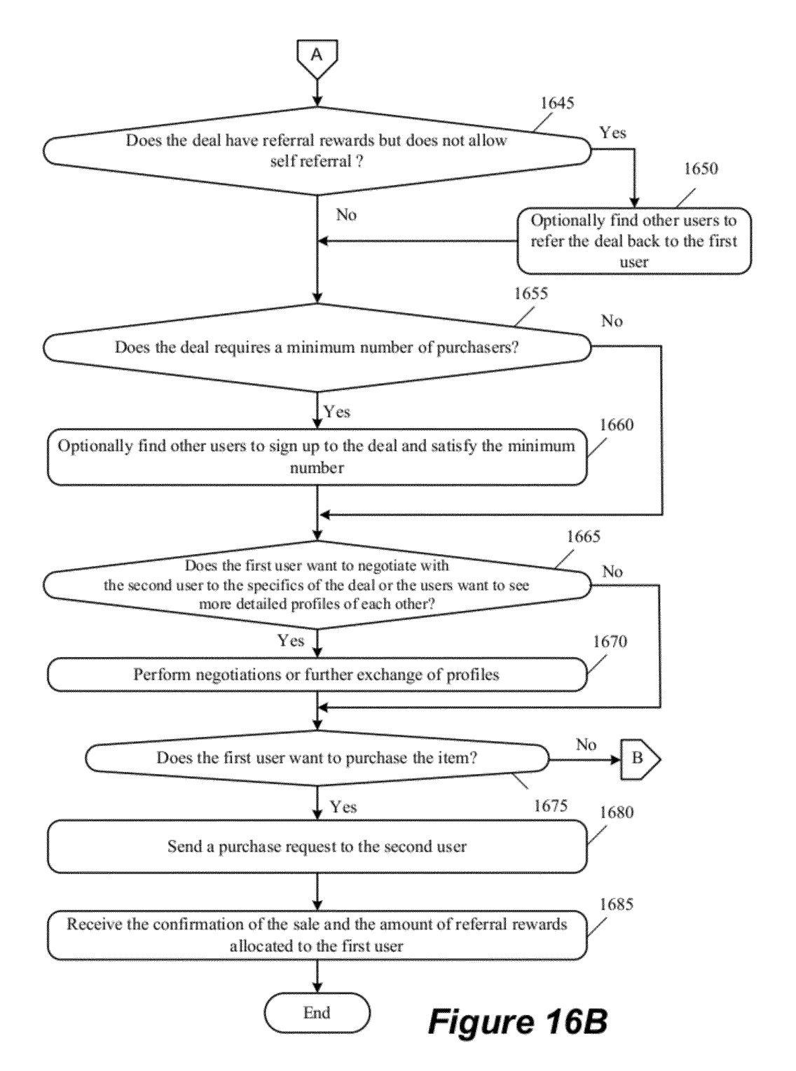

FIG. 16 conceptually illustrates a process 1600 for providing P2P/ad-hoc networking among shoppers in some embodiments of the invention. As shown, the process establishes (At 1605) a P2P communication network between a group of wireless mobile devices. As described above, the mobile devices in some embodiments utilize an ad-hoc social networking application to establish the P2P (or ad-hoc) network. In some embodiments, each the wireless mobile device of each user is set to communicate with other wireless mobile devices of the P2P network that are within a customizable distance.

Next, the process optionally sends (at 1610) a first user's shopping profile (or just sends a message) that includes one or more items to purchase to one or more other users of the P2P network. As described above, some buyers are proactive and broadcast their shopping profiles to others while the others are passive and just receives profiles of the sellers.

The process then receives (at 1615), at the wireless mobile device of the first user, a message or a shopping profile of a second user that has one or more items to sell. The process then determines (at 1620) whether the first user wants to refer the deal to others and receives referral rewards if any items that the second user is selling have referral rewards. If not, the process proceeds to 1635 which is described below. Otherwise, the process sets (at 1625) a portion of the rewards that the first user is willing to share and sends the deal to other users. The process then receives (at 1630) a credit for the first user equal to the difference between the rewards offered by the second user and the rewards offered by the first user when the item is purchased by a user that was referred the item by the first user. The details of operations 1625 and 1630 are similar to operations of process 600 (e.g., operations 610-635) and are not repeated here for brevity.

The process determines (at 1635) whether the second user is offering an item that the first user is interested to purchase. For instance, the shopping profile of the second user has an item for sale and the shopping profile of the first user has the same item to purchase. As another example, the second user sends a message for an item to sell, the item is displayed to the first user, and the first user chooses the item to purchase. If the second user doesn't have any item that the first user is interested to purchase, the process proceeds to 1610 which was described above.

Otherwise, the process optionally establishes a communication outside the P2P network between the first user's wireless mobile device and a server or a web site to check the credentials of the second user and/or to get more details about the item offered for purchase.

The process then determines (at 1645) whether the item has a referral rewards but does not allow self-referral (i.e., the purchaser cannot get referral rewards). If not, the process proceeds to 1655 which is described below. Otherwise, the process optionally (when the first user wants to do self-referral) finds (at1650) other users to refer the deal back to the first user. Details of operation 1650 are similar to operations of process 700 and are not repeated here for brevity.

The process then determines (at 1655) whether the item requires a minimum number of purchasers or minimum number of items to be sold. If not, the process proceeds to 1660 which is described below. Otherwise, the process optionally finds other users by broadcasting the deal from the first user's wireless mobile device to other P2P network users to have more users to sign up for the deal.

The process then determines (at 1665) whether the first user wants to negotiate with the second user about the specifics of the deal or the users want to receive more detailed profiles of each other (e.g., when either one or both of the first and second users had send an initial or summary profile). If not, the process proceeds to 1675 which is described below. Otherwise, the process sends (at 1670) messages or profiles from the wireless mobile device of the first user to the wireless mobile device of the second user or receives (at 1670) messages or profiles at the wireless mobile device of the first user from the wireless mobile device of the second user.

The process then determines (at 1675) whether the first user wants to purchase the item. If not, the process proceeds to 1610 which was described below. Otherwise, the process sends (at 1680) a purchase request to the second user. The process then receives (at 1685) the sale confirmation and the amount of the referral rewards (if any) allocated to the first user. The process then exits.

### V. Multi-Hop Social Networking Reward System

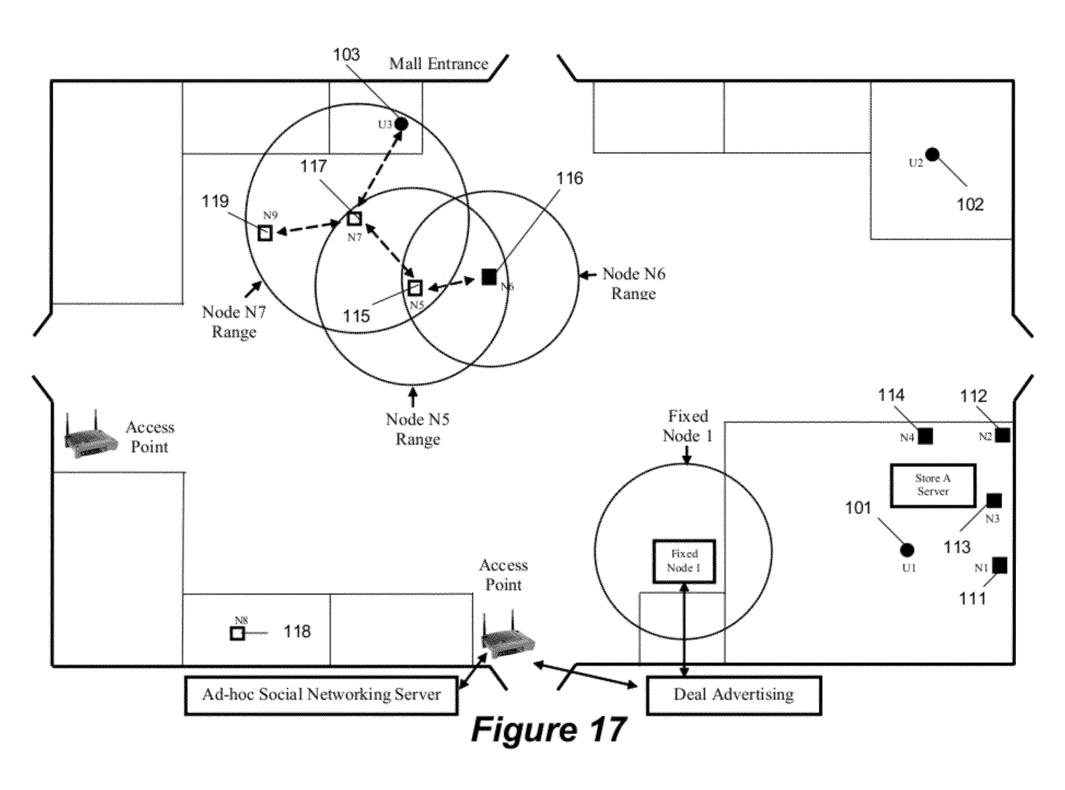

FIG. 17 conceptually illustrates the position of the shoppers of FIGS. 1, 2, 12, and 15 at a later time instance. Newly joined members N1 111, N3 113, and N6 116 are shown as black filled squares to signify that they are now registered with the deal advertising company. Members N1 111, N2 112, N3 113, and N4 114 have gone to the store to redeem the dinner they purchased. FIG. 17 also shows another mode of operation where multiple hops are used to inform a non-member user about the deal. In this figure the mobile device of member user N6 116 forwards the deal to the mobile device of non-member user N5 115. User N5's mobile device then forwards the deal to non-member user N7's mobile. The mobile device of user N7 117 then forwards the deal to the mobiles of both non-member user N9 119 and member user U3 103. In this example user U3 does not have a regular network connection such as Wi-Fi or cellular. This illustrates that some members receive deal advertisement from other members. A member that has a regular wireless network connection can also receive deal advertisements directly from the deal advertising server and indirectly from nearby members that use ad-hoc social networking

Three different networking modes of operation and rewards system can be implemented for multiple hop scenarios, such as FIG. 17. A first case is where the mobile devices of e.g., intermediate users (N5 115 and N7 117) act as networking node routers and forward the personal referral link and message of the original source user (N6 116) to destination users (N9 119 and U3 103). In the event that a destination user purchases the deal, the advertising server gives the rewards to the original referral source user (N6 116). Multiple sources are allowed to each have their personalized referral links and forward the same deal to one destination. If a destination user receives multiple referrals for the same deal he can then decide which referral link to use.

A second case is where each intermediate user accesses the deal advertising server, sets up an account if not already registered, gets a personalized referral link and message, and forwards to the next user. If the destination user purchases the deal then the last referral node gets the reward (e.g., if N9 119 or U3 103 purchase then N7 117 gets the rewards). A third case is a hybrid scenario where some intermediate users register with the deal advertising server and get their personalized referral links and messages, while others just forward the personalized links and messages they receive.

With regards to the first case above, intermediate users that act as routers and forward the personalized referral links and messages of other users are using the resources of their mobile device, such as battery energy and CPU. These users may not want to get their own personalized referral links but might demand to be rewarded in some way if they are to allow others to use their mobiles as routers in an ad-hoc network. One variation in the reward sharing method of FIG. 4 is for the original referrer to specify a separate shared reward amount for intermediate routers. For example, the referrer N6 116 can specify in his referral page that he will share 30% with the purchaser and 20% with intermediate routers.

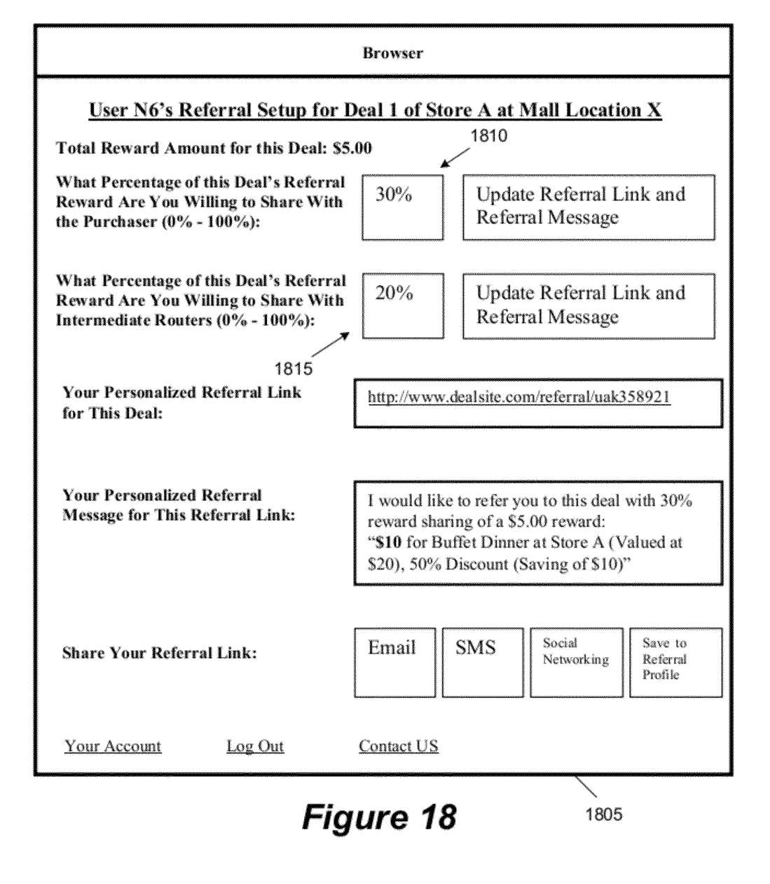

FIG. 18 conceptually illustrates an example of a referral setup to share rewards with a purchaser as well as intermediate routers in some embodiments of the invention. As shown, the referral setup 1805 of user N6 states (as shown by arrow 1810) that the user is willing to share 30% of the deal reward with the purchaser. The referral setup 1805 also states (as shown by arrow 1815) that the user is willing to share 20% of the deal reward with the intermediate routers. Then in FIG. 17 if user N9 119 purchases the deal 30% of the rewards goes to user N9 119, 20% is shared between intermediate router users N5 115 and N7 117, and 50% goes to the original referrer N6 116.

In order for such a scheme to be implemented routing information in the ad-hoc network needs to be maintained. Routing information is in the third network layer of the Open System Interconnection model (OSI model) in some embodiments of the invention (the first layer is the physical layer and the second layer is the data link layer). The application layer, which is the seventh layer in the OSI model, can be modified to keep the packet headers and maintain the routing information. Then for example, the purchaser N9 119 can inform the deal advertising server that the referral link from user N6 116 got to her via the mobile devices of users N5 115 and N7 117. Intermediate routers can for example, at the application layer, check the reward sharing criteria for intermediate routers. These routers may choose to be selective and only act as intermediate routers if they get a certain minimum percentage of the referral rewards. Intermediate routers get their portion of the reward when the purchaser purchases the deal.

Different embodiments for multiple offers, negotiation between the users, sharing of the rewards, self-referral, P2P networks, etc., that are discussed throughout this Specification also apply to multi-hop networks and are not repeated for brevity.

Some embodiments utilize a process similar to processes 600 and 1600 to provide multi-hop networking among shoppers in some embodiments of the invention. In these embodiments, in addition to the wireless mobile devices of the users that are actively exchanging messages and profiles to buy and sell items, the mobile devices of other users of the multi-hop network (with the authorization from their users) are used as routers to forward the messages or profiles of different users that are participating in a deal to their destinations.

In these embodiments, the portion of referral rewards that a user is willing to share with others (e.g., in operation 610) not only includes a portion of the referral rewards to share with the referrer (or the purchaser in case self-referral is allowed) but also includes a portion of the referral rewards to share with other users of the multi-hop network who allow their mobile devices to be used as routers for forwarding the deal. When an item is purchased, the ad-hoc social networking application identifies each wireless mobile device that has been used as an intermediate router that forwarded the deal to the final purchaser and allocates a share of the referral rewards to these users as described above.

VI. Multiple Referrals for the Same Deal with Different Reward Sharing

FIG. 19 conceptually illustrates users receiving multiple referrals for the same deal from different members in some embodiments of the invention. As shown, non-member user N9 receives multiple ad-hoc social networking referrals for the same deal from different members (U1 101, N6 116 and N4 114), each with a different reward sharing parameter. In FIG. 19 at time T0 user N9 is at a particular position 1905 and N9's mobile receives U1's personal referral link and message for deal 1 with a 40% reward sharing parameter. At time T1 the position of user N9 has changed (as shown by 1910) and is within the transmission range of the mobile device of user N6 116. The mobile device of user N9 then receives N6's personalized referral link and message for deal 1 with 50% reward sharing. At time T2 user N9 has moved closer to user N4 114 (as shown by 1915) at which point N9's mobile device receives N4's personalized referral link and message with no reward sharing. At time T3 (as shown by 1920) user N9 uses his mobile device and checks the three referral links. After comparing the three referrals user N9 uses his mobile device to register with the deal advertising server 150 and purchase deal 1 with the referral link from user N6 116 because that link offers the highest reward sharing percentage. This figure can be generalized to cases where user N9 receives multiple referrals at the same location and/or time from nearby referrers, as well as multiple referrals at different times/locations.

In some embodiments user N9 negotiates with one or more referrer to obtain a better reward sharing parameter prior to purchase. For instance, in FIG. 19 after receiving the three referral links user N9 can communicate with user U1 101 (using a P2P wireless connection or a wireless access point) and let him know that he intends to use another referral (N6's) unless U1 101 increases his reward sharing parameter to greater than 50%. User N9 effectively creates a reverse auction amongst users U1 101, N6 116 and N4 114 in order to obtain the best reward sharing percentage. Referral reward negotiation also occurs just between two users (the referrer and the referred). For example, in FIGS. 12 and 13 user N4 114 can ask user U1 101 for a better reward sharing parameter. The negotiation can be initiated by user N4 114 or it could be automated with a reward negotiator software agent on the mobile device of user N4 114.

FIG. 20 conceptually illustrates the same process of FIG. 19 for conventional server-based social networking referrals in some embodiments of the invention. In FIG. 20 members U1 101, U20 120 and U21 2005 receive the deal 1 coupon on their computing devices from the deal advertising server. Each one of the members then uses their computing device and contacts the deal advertising server 150 with conventional wired or wireless networks, specifies a referral rewards sharing parameter, obtains a personalized referral link/message and forwards it to N20 120 using conventional communication and networking methods.

Non-member user N20 120 then reviews the referrals, registers with the deal server 150 and purchases the deal with the referral link of user U21 2005 because it offers the highest reward sharing parameter. As with the ad-hoc networking case of FIG. 19, user N20 120 can also negotiate to obtain a better reward sharing parameter.

### VII. Pre-Existing Deal Offering

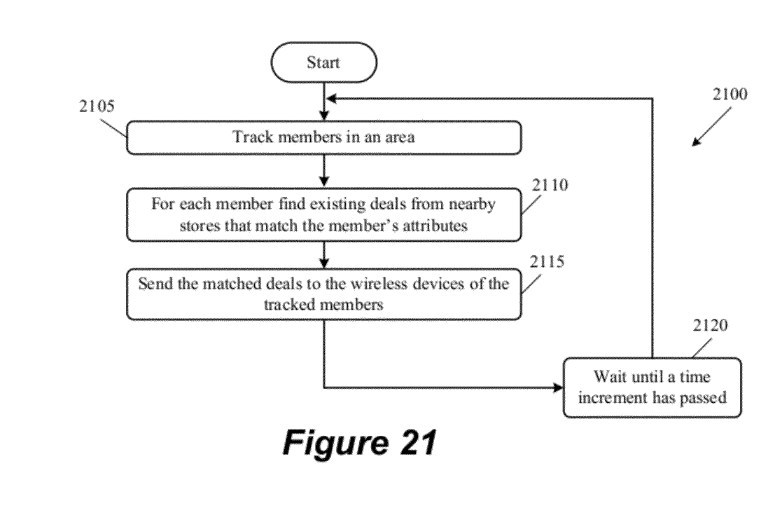

FIG. 21 conceptually illustrates a process 2100 for a product and store-based approach in some embodiments of the invention where the deal server tracks members and forwards “pre-existing” store deals to the members in order for the members to purchase the deal and/or make referrals to nearby non-members or members. As shown, the process tracks (at 2105) the position of members in an area (e.g., by using the location server). The process then finds (at 2110) deals that match the users' attributes. For instance, for each tracked user, the process in some embodiments computes statistical measures between the user's attributes (such as position, velocity, profile, transaction history, referral history, wish-list, shopping list, and referral history) and pre-existing deals and uses the computed statistics to find the deals.

The process then sends (at 2115) one or more matched deal advertisements to the devices (e.g., wireless devices) of the users. In some embodiments, when there is more than one user that matches a deal, the process broadcasts the deal to all matched users. The advertisement notification is made through different mediums such as email, text or instant message, voice message, and social networking (e.g., Twitter™, Facebook™), as well as less intrusive pull-based applications and deal server's portal web pages and messaging system. The advertisements are optimized for users' mobile devices in some embodiments. In some embodiments, the advertisements include a dynamic map that shows the location of all nearby deals. Examples of web page interfaces are shown in FIGS. 3 and 25-27. The process then waits (at 2120) for a predetermined amount of time and then proceeds to 2105 to repeat tracking of the users and broadcasting deals in order to update new user attributes (e.g., new position) and new deals from stores. If a member is logged in to the deal server's web site with a browser or a dedicated application then the member can view up-to-date dynamic maps with his/her position and nearest deals. The deal server in some embodiments detects the login status and avoids sending notifications through other means such as email or SMS.

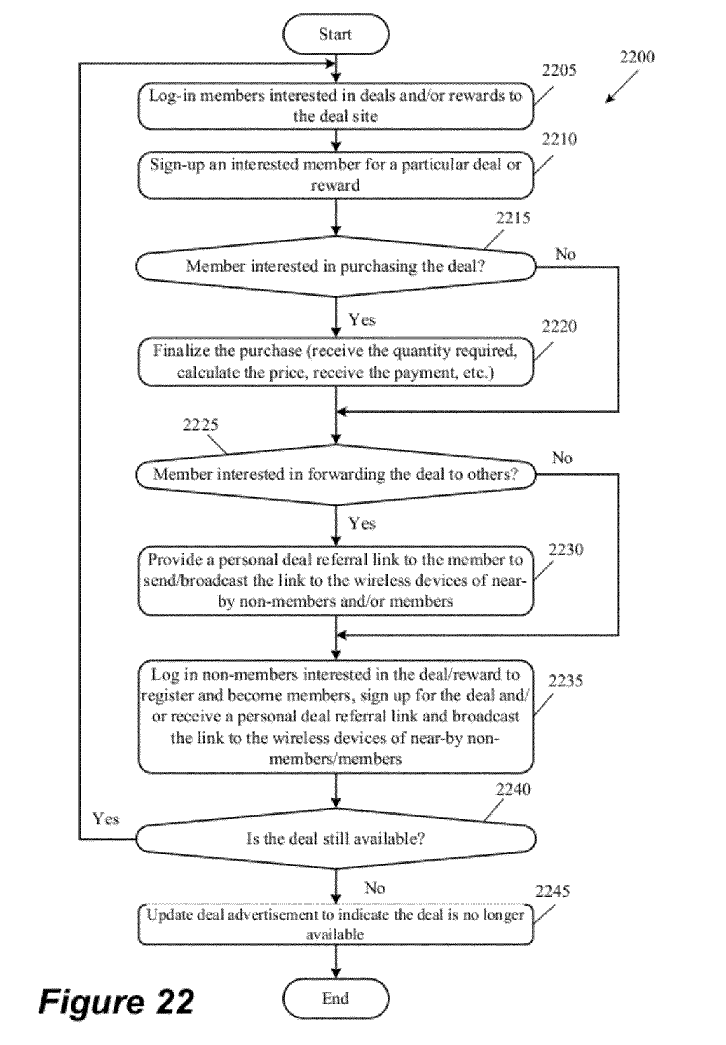

FIG. 22 conceptually illustrates a process 2200 of the deal server in some embodiments of the invention to allow users to login to deals and either purchase a deal or forward the deal to other members and non-members. The process is described for one member and one advertised deal, but can be generalized to multiple members and multiple deal advertisements for each member. For each received deal advertisement a member can ignore it, sign-up to purchase the deal, and/or refer it to others. As shown, the process logs in (at 2205) each member that is interested in the deal or a reward related to the deal (if the member is not already logged to the deal server) and signs up the member for a particular deal or reward. The process signs up (at 2210) the member who wants to purchase the deal either through the deal server web site or an application that is loaded on the member's device.

The process then determines (at 2215) whether the member is interested in purchasing the deal. If not, the process proceeds to 2225 which is described below. Otherwise, the process finalizes (at 2220) the deal if the deal conditions are met. For instance, the process in some embodiments receives the quantity to purchase, calculates the price, calculates the taxes, receives the shipping address, receives the payment, etc., to finalize the deal. In some embodiments, the process utilizes the transaction server associated with the deal server to charge the member and credit the store. If the deal purchase results in any rewards for the purchasing member then the account of the member is awarded the rewards.

The process then determines (at 2225) whether the member is interested in forwarding the deal to others. If not, the process proceeds to 2235 which is described below. Otherwise, the process provides (at 2230) a personal deal referral link to the member to allow the member to send or broadcast the link to the wireless devices of near-by members and non-members. If the member is interested in making a referral the member specifies reward sharing parameters, receives a personal referral link and message, and broadcasts the personalized link/message together with other deal attributes to other users. The member makes referrals by using either standard networking infrastructure and communication servers (as described by reference to FIG. 20 with email, chat, text message, conventional server-based social networking, portal web pages) or by using P2P wireless networking and ad-hoc social networking (as described by reference to FIG. 12, above).

The process then logs in (at 2235) the referred non-members to the deal server to view the deal, register, sign-up for the deal with the referral link if interested in it. If a referred user (member or non-member) receives multiple referral links, the referred user can choose the best reward sharing link. A non-member who becomes a member can receive his/her own personal referral link/message and broadcast the referral link/message and other deal information to the wireless devices of other near-by shoppers (or make referrals using standard networking infrastructure and communication servers).

The process then determines (at 2240) whether the deal is still available. If yes, the process proceeds to 2205 to continue log-in and sign up interested users to the deal. Deal referrals and sign-ups/purchases continue until the deal is no longer available (e.g., time deadline has passed or all store discount items have been purchased). The deal advertisement is then updated (at 2245) to indicate that the deal is no longer available. The process then exits. This process is repeated for all advertisements sent to members and all members who receive advertisements.

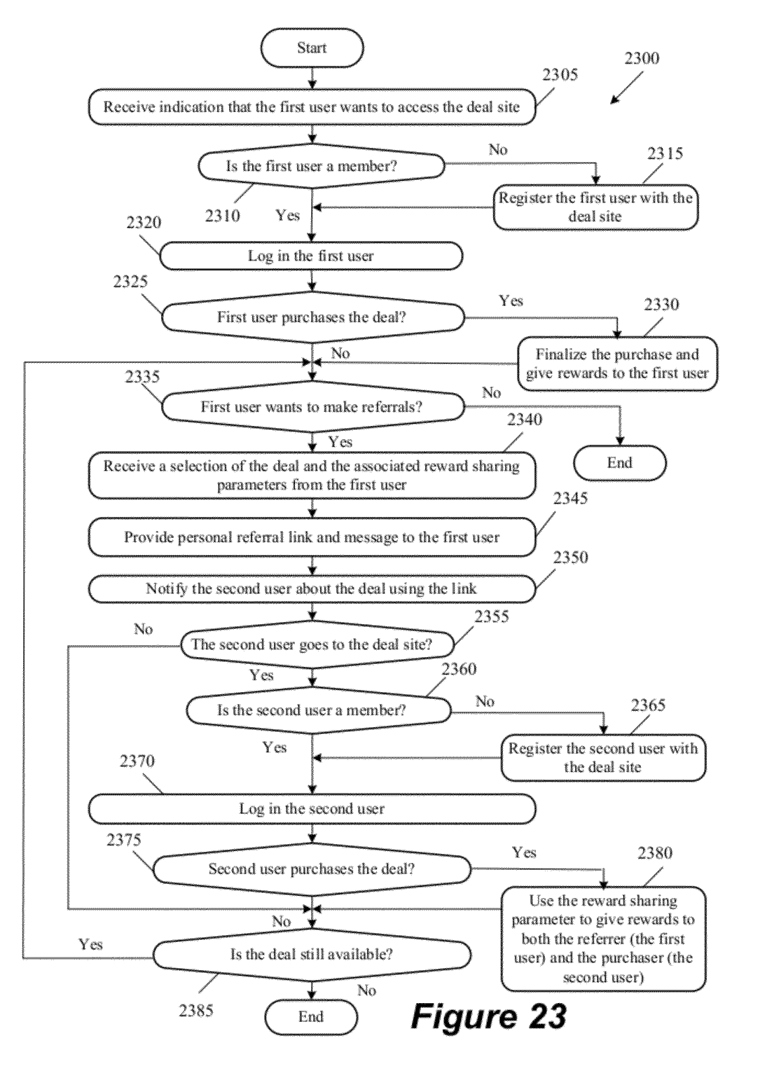

FIG. 23 conceptually illustrates a process 2300 for deal referrals by a first deal recipient to other shoppers in some embodiments of the invention. As shown, the process receives (at 2305) an indication that a deal advertisement recipient (referred to as the first user) has initially gone to the deal site to view the deal. The process then determines (at 2310) whether the first user is a member. If yes, the process proceeds to 2320 which is described below. Otherwise, the process registers (at 2315) the first user with the deal site.

Next, the process logs in (at 2320) the first user. The process then determines (at 2325) whether the first recipient wants to purchase the deal. If no, the process proceeds to 2335 which is described below. Otherwise, if the deal conditions are met, the process finalizes (at 2330) the purchase by charging the first user's account (e.g., by using the transaction server associated with the deal server) and crediting the store. The process also deposits (at 2330) rewards to the accounts of the referrer and purchaser.

The process then determines (at 2335) whether the first user wants to make referrals. If the user does not want to make referrals, the process ends. Otherwise, the process receives (at 2340) a selection of the deal from the user (e.g., when the user selects the deal's referral page and specifies reward sharing parameters). The process then provides (at 2345) a personal referral link/message to the user.

Next, the process receives a command from the user and forwards (at 2350) the link/message and other deal attributes to a second user. The process then determines (at 2355) whether any other user (in this example the second user) wants to access the deal site. If no, the process proceeds to 2385 which is described below. Otherwise, the process determines (at 2360) whether the second user is a member. If yes, the process proceeds to 2370 which is described below. Otherwise, the process registers (at 2365) the user with the deal site as a new member.

The process then logs in (at 2370) the second user. The process then determines (at 2375) whether the second user has purchased the deal. If no, the process proceeds to 2385 which is described below. If yes, the process uses (at 2380) the reward sharing parameter to give rewards to both the referrer and the purchaser. The process then determines (at 2385) whether the deal is still available. If not, the process exits. Otherwise, the process proceeds to 2335 to allow the first user to make more referrals. The process continues until the first recipient is no longer interested in making referrals or the deal is no longer available. A similar process is performed for every user that is interested in the deal and accesses the deal site.

### VIII. Dynamically Formed Deal Offering

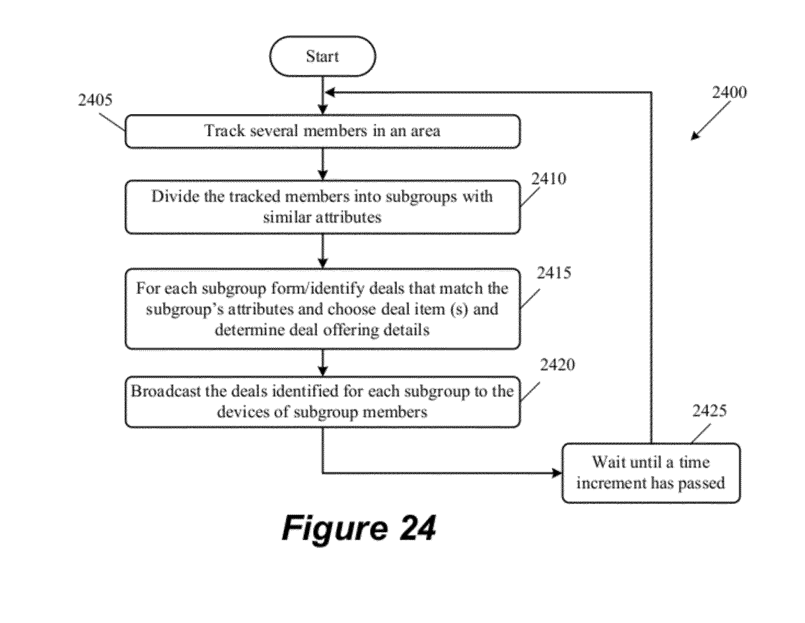

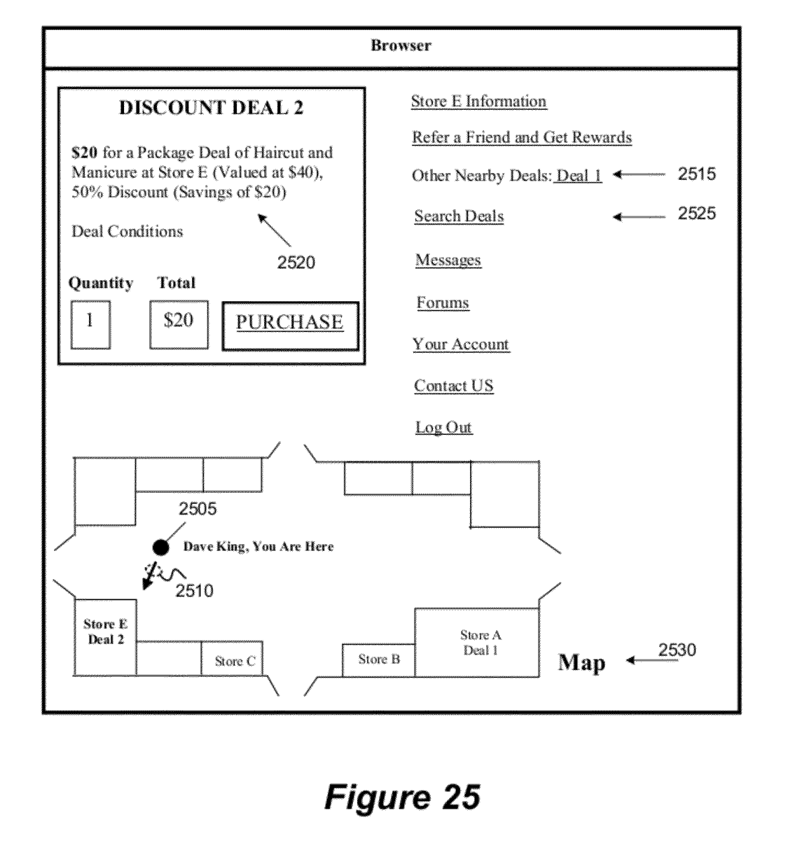

FIG. 24 conceptually illustrates a process 2400 in some embodiments of the invention for a user-based approach where the deal advertising server tracks several member users in a local vicinity, divides the users into subgroups, “dynamically” generates one or more deals to match each subgroup, forwards the deals to subgroup members, and the subgroup members make referrals to nearby non-members/members. Unlike the approach shown in FIG. 21 that was product and store-based, this approach is user-based. Because the process starts with subgroups of people, the resulting deals can involve multiple items from a single store or multiple items from multiple stores (As described by reference to FIGS. 25-27, below).

As shown in FIG. 24, the process tracks (at 2405) the position of several members in an area (e.g., by using the location server 175 shown in FIG. 1). Next, the process divides (at 2410) the tracked members into subgroups with similar attributes. For instance, process 2400 in some embodiments utilizes the deal server in conjunction with the data mining server and other associated servers to analyze the attributes of members. These attributes include position, velocity, profile, transaction history, wish-lists, shopping lists, and referral history. The process then divides the users into subgroups with similar attributes.

Next, for each subgroup, the process forms deals (at 2415) that match the subgroup's attributes. In order to formulate deals, process 2400 in some embodiments utilizes the advertising server and other servers such as the data mining server to compute statistical measures for each store within the vicinity of the subgroup. The computed measures include (but are not limited to) the number of nearby members, the members' potential collective purchasing power for different store items, the number of likely buyers for each store item, the total amount that members are likely to spend at the store to buy any items, the average value that a member is likely to spend at the store, the number of expected advertising referrals using conventional methods, and the number of expected advertising referrals using ad-hoc social networking

One advantage of statistical measures that consider user referrals is using a lower threshold for the number of users that are currently identified for purchasing a product before a deal offer for the product is sent to the users. For instance, consider that a store requires 50 or more users in order to offer a deal for a particular product. However the advertising server has only identified 30 users that currently satisfy the criteria for purchasing the particular product (e.g., these users have indicated in their shopping profile that they are willing to purchase the particular product at or below the price of the product indicated in the deal). If the advertising server and/or its associated servers compute statistics from previous referral histories of the 30 currently identified buyers and determine that there is a high likelihood that these buyers will refer the deal to other buyers and will bring in 20 or more buyers to purchase the deal, then the deal server sends the deal for the particular product to the 30 identified buyers. In some embodiments, the criteria for offering a deal is whether the number of buyers currently identified to purchase the deal satisfies a certain threshold while in other embodiments the criteria for offering a deal is whether the number of currently identified buyers as well the number of potential referrals (and conversion rate of those referrals to purchases) from buyers and non-buyers (e.g., as determined from the statistical measures) satisfies the threshold.

Once the process has computed the statistical measures, the process makes a decision as to whether to offer a customized group discount deal for each store. If a particular store profile has deal offering rules, such as minimum purchasing power or a minimum number of buyers required for offering a deal, then the process makes the determination, taking into account that ad-hoc social networking will advertise the deal further and increase the number of nearby members and their purchasing power.

For example, in FIG. 1 store A may require a minimum of five buyers to make a deal offer. The deal advertising server communicates to the server 142 of store A 130 that two of its members (U1 101 and U2 102) are close by and are potential buyers. Store A decides to offer a deal and notifies the deal advertising server 150 to advertise the deal to its members because based on previous history (as determined by the deal advertising server 150 and the data mining server 180 and communicated to store A server 142) there is a high likelihood that the two members U1 101 and U2 102 will use ad-hoc social networking and find at least three other buyers in their proximity in order to receive extra rewards (or to make the deal valid if the deal condition states five minimum buyers are required to make the deal valid).

If the store does not have deal offering rules, the statistical measures are communicated to the store. In some embodiments, this is done using human communication (e.g., telephone calls) or electronically with the deal server communicating the statistics to the store server. The store can then decide if a customized deal is offered. This could be done using human decision making or it could be automated with the store server looking up the store's business rules from a database or memory. Again the decision process takes into account that ad-hoc social networking will advertise the deal to non-members. If a deal is not offered from any store, the deal advertising server continues to track the users and the process continues until a deal is offered.

In some alternative embodiments to process 2400, a store is interested in dynamically forming a customized group discount deal. In these embodiments, the process receives (at 2415) the deal from the store (e.g., after the store and/or the deal advertising server choose a store item or set of items to be sold for the deal). In some embodiments the selected item is a gift card for the store. A gift card has the advantage that it can be used to purchase a variety of items from the same store and hence can appeal to a larger group of buyers with different profiles and shopping lists. For example, one user can use it for a wish-list item while another user can use it for a different item.

If the store is not interested in offering a gift card deal but only specific items then the store in some embodiments uses the statistical computations of the deal advertising server for different store items and chooses an item or set of items. The decision as to which items to offer could be based on different business criterion such as maximizing the total purchasing potential power, maximizing the number of buyers, inventory levels, etc. After the deal item is chosen the details of the discount deal are determined by the store, by the deal advertising server and its data mining server, or jointly together. Since these deals use the current location of a group of potential buyers the store may offer the deals for a short duration (e.g., a few hours) in order to get quick participation from the buyers. The data mining server in some embodiments makes suggestions to make the deal more attractive to potential buyers. The stores also have certain business rules that determine a range for some of the deal parameters. For example, the deal may only be available (i) at a certain discount function (e.g., fixed 10% discount for all buyers, or varying discount levels where the first 10 buyers get x % discount and the rest get y % discount), (ii) for a limited time period (e.g., from noon to 3 PM), (iii) while a maximum available number of items are not sold out (e.g., until all 50 items in stock are not sold), or (iv) if a minimum number of items are requested by potential buyers (e.g., at least 20 buyers must accept the deal for the deal to be valid).

If the deal involves multiple items, the details of the deal offering have to take into account the constraints of multiple items from one or more stores. Once the details of the deal are determined, process 2400 broadcasts (at 2420) the deal advertisement (e.g., by using the deal advertising server) to the wireless devices of subgroup members. Once the deal is broadcast to members, the members (and subsequently the non-members) utilize process 2200 described by reference to FIG. 22 to purchase the deal(s) and/or to receive rewards.

The above processes 2400 and 2200 are repeated for all advertisements sent to a subgroup of users, and all subgroups who receive advertisements. The process of tracking users and broadcasting deals is repeated after a certain time increment has passed (at 2425) in order to update new user attributes (e.g., new positions) and new deals from stores. Process 2400 was described for one store. This process is repeated for all nearby stores in the deal advertising server's database. The users in some embodiments receive one advertisement notification that shows all nearby deals. For instance, the advertisement in some embodiments is a dynamic web page or a portal web site that shows a map with the location of all nearby custom deals that are directed at a particular user (as described by reference to FIGS. 3 and 25-27).

In some embodiments processes 2100 and 2400 are utilized in conjunction with each other. For instance, when the user-based approach of process 2400 does not result in any deals (e.g., not enough registered user are present and/or potential purchasing power is too low) then the server reverts to product and store-based approach of process 2100 and forwards relevant pre-existing nearby deals to individual members. In some alternative embodiments to process 2400, a store approaches the deal advertising server and picks an item/package for a deal in advance. Once the process receives (at 2415) the picked up deal, the process (e.g., by utilizing the deal advertising server) tracks users and calculates statistics such as collective purchasing power of users for that item/package only. A decision is then made as to whether to offer the deal or keep monitoring the users and recalculating the statistics for that item/package. If a decision is made to offer a deal then the details of the deal offering are determined. Once the details of the deal are determined, the deal server advertises the deal to a subset of the tracked users who are characterized as potential buyers and/or referrers.

A. Deal Formulation Cases

The data mining server and the deal advertising servers play a critical role in the flow chart of FIG. 24 since they are involved in dividing the users into subgroups with similar attributes, computing statistics, recommending single or package items for the deal advertisement, and determining the details of the deal offering. Below are some deal formulation cases.

1. Single Item from a Store

A store has the computed statistical values (for each of its individual product items) of the total purchasing power of the subgroup of users, the number of likely buyers, and the number of likely referrers. The store then decides if it wants to offer a deal and if so which item it wants to offer. For instance, the store can decide to offer a deal item that maximizes the total purchasing power. Alternatively, the store can maximize the number of buyers and/or referrers.

2. Gift Card for a Store

The deal server calculates the average amount that buyers are likely to spend at the store. The store can use this estimate to decide if it wants to offer a gift card and if so what the amount of the gift card should be.

3. Multiple Items from a Store

The deal server together with the data mining server chooses different permutations of items from a store and performs statistics calculations. Data mining can focus the permutations to high probability sets. For example the data mining server in some embodiments determines that buyers who are interested in a haircut are also likely to be interested in a manicure at the same salon. The servers can calculate the purchasing power of users for different set of product items. The store can then decide whether to advertise a deal and if so what set of items to use for the deal.

4. Multiple Items from Multiple Stores

If two or more stores are interested in offering a multiple item package deal from multiple stores they can supply the set of items to the deal server. The stores may also use the deal server and the data mining server to make suggestions for grouping of stores and items. The deal server and data mining server then perform statistics calculation. Data mining in some embodiments can focus the permutations to high probability sets where the set of items from different stores are complementary. For example, the data mining server determines that people going to dinner at a restaurant may also be interested in going to a nearby movie theater. The stores can then use the results to decide whether they want to offer a deal and which set of items to offer.

### IX. Examples of Deals

FIGS. 25-27 illustrate more deal advertisement examples as viewed on the mobile devices of users in some embodiments of the invention. FIG. 25 conceptually illustrates the advertisement in some embodiments of the invention where a tracked member (e.g., Dave King in FIG. 3) has moved to a new location. In these embodiments as the member moves around, the featured deal changes to show the nearest location store deal that is customized for that member. As shown in FIG. 25, with the member's new position (2505) and new velocity (2510), the targeted advertised deal has changed from deal 1 in store A (as shown in FIG. 3) to deal 2 at store E. As shown in FIG. 25, deal 1 at store A is now a nearby deal 2515 and not the targeted deal. The user may also have the option to filter out some deals and view one deal or a subset of the deals. Deal 2 is an example of a multi-item package deal from one store since it is a 50% discount on a haircut and a manicure at store E (as shown by arrow 2520). In some embodiments when some of the package deal items are available but other deal items are not available, the deal advertisement is updated so that the remaining items can still be advertised. For example, a two-item deal reverts to a one-item deal after one of the items is no longer available. In other embodiments other items are added to the deal and the advertised deal is updated.

Registered and un-registered users can disable position tracking on their mobile devices for privacy reasons or other reasons and still login and view the web site of the deal adverting server. However, if the advertising server does not know the position of the user, the map 2530 will not display the user position (e.g., as described by reference to FIG. 14) and will not move as the user moves around. Instead, the user would have to navigate the map manually. For example, users can scroll and zoom the map to see deals at different locations in a mall. The user can also use the “Search Deals” 2525 feature with advanced settings that allow location constraints on the search. The position of a non-tracked user is also estimated in some embodiments if the user communicates with a tracked member using the P2P mode. Thus, if the advertising server is notified of that communication, the position of the non-tracked user is estimated to be near the tracked user and hence the map is adjusted accordingly.

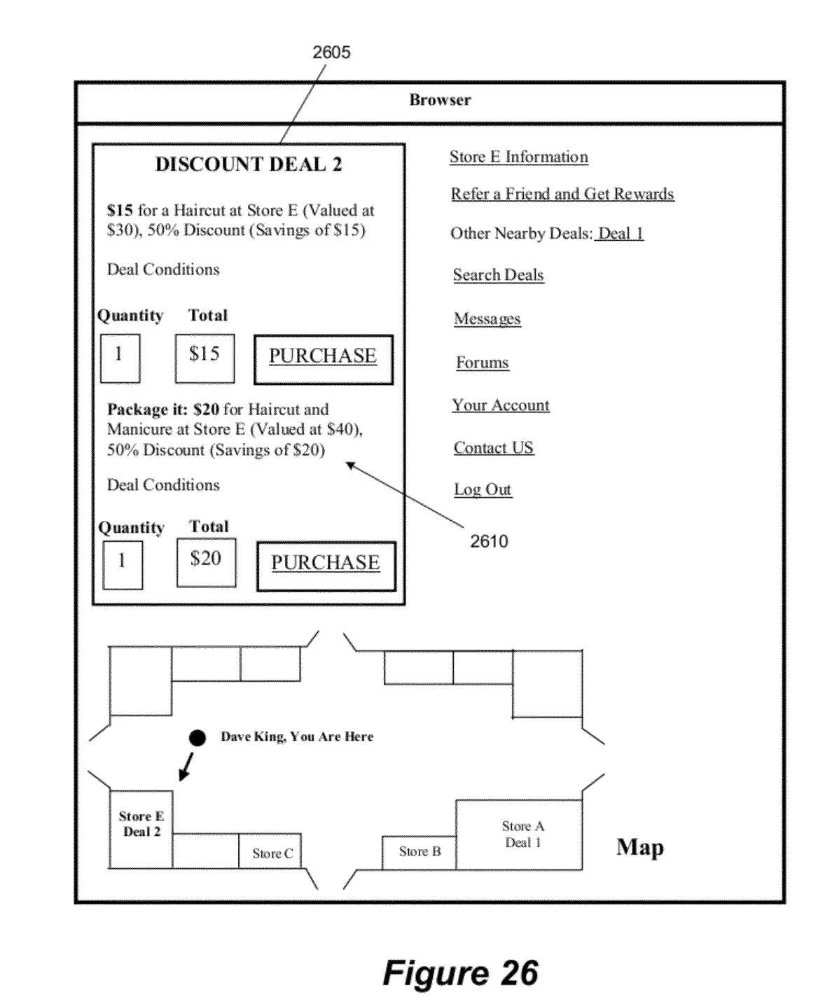

In some instances the results of the statistical calculations of the deal server and the data mining server demonstrates that there are benefits to offering a single item deal as well as a package deal. For instance some user and store attribute information may not be precise and as a result the calculations lack precision as to whether some users are interested in the single item deal or the package deal. Since the single item deal and the package deal are closely related one option is to present the two deals together on one advertisement and allow the members to choose, as shown in FIG. 26. FIG. 26 conceptually illustrates advertisement in some embodiments of the invention for a tracked member (e.g., Dave King in FIGS. 3 and 25). As shown in FIG. 26, deal 2 is an example of a single item deal 2605 of a $15 haircut at store E with an option to purchase (as shown by arrow 2610) a package involving an additional manicure for $5 extra.

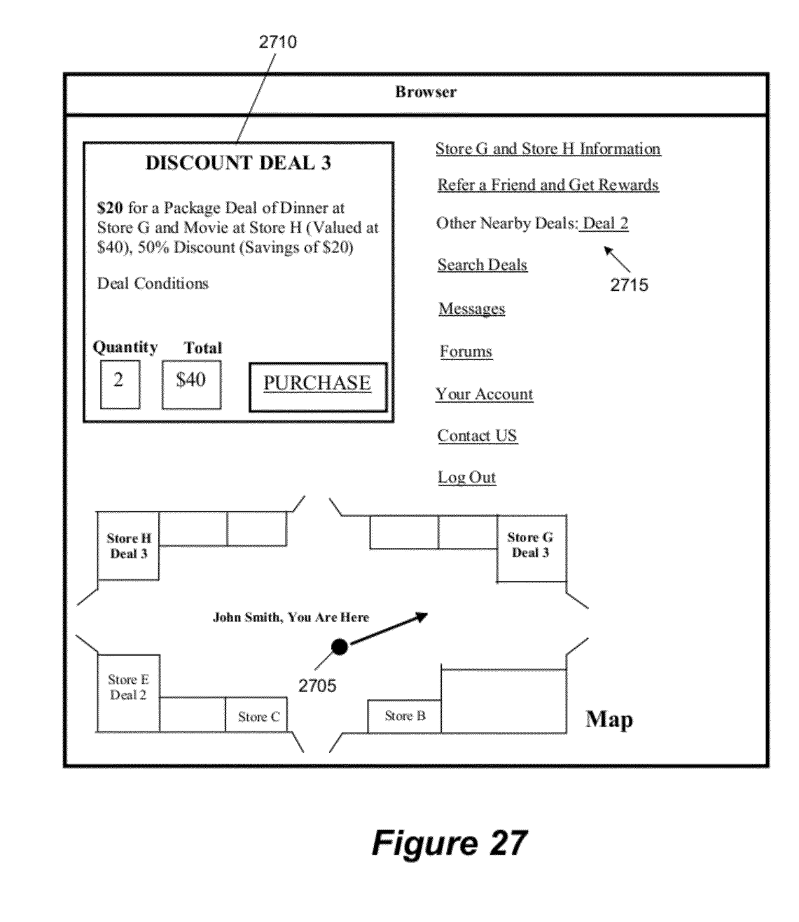

FIG. 27 conceptually illustrates advertisement on a mobile device of a tracked member in some embodiments of the invention. In this example, John Smith has different attributes than Dave King (which was described by reference to FIGS. 3, 25, and 26). Therefore, the deal server targets John Smith with different advertisements (deal 3 and 2, but not deal 1). With his marked position 2705 in FIG. 27, John Smith's advertisement shows deal 3 as the featured deal (2710), and deal 2 as the next nearest deal (2715). Deal 3 is a package deal involving dinner at a restaurant (store G) and a movie at a nearby theater (store H).

FIG. 28 conceptually illustrates an example of deal advertising in some embodiments of the invention. The figure demonstrates embodiments where a member of a deal advertising server uses ad-hoc social networking to find another shopper to share the purchase of one deal with. In this example, member U1 has a shopping list that gets transferred to a deal advertising server 2810. One of the items on his shopping list is one gallon of whole milk. The deal advertising server contacts store K 2815 and store K comes up with a regular one gallon whole milk purchase and a deal for two gallons of whole milk. The deal is advertised to member U1 either by the deal advertising server, or as the diagram shows directly by the store. User U1 then uses ad-hoc social networking to find another nearby shopper, N4, who is in store K or nearby and who also wants just one gallon of whole milk. They then share the two gallons together so it is cheaper for both of them rather than each buying one gallon of milk separately. This could be generalized to more than two shoppers sharing the purchase of items together.

The sequence of steps is as follow: (1) User U1 transfers his shopping list to a first server (deal advertising server). The diagram illustrates that user U1 enters the mall and wirelessly transfers his shopping list to a mall kiosk 2805, which forwards it to a deal advertising server 2810. However, the member could also have transferred the shopping list to the server from home or work and stated that he intends to go to that particular mall to shop for the items, (2) First server 2810 contacts nearby store servers and gives them the shopping list and U1's contact information. Store K 2815 has one gallon milk and comes up with a regular price of $2.99 and a deal to buy 2 for $4.00. Store K's server 2820 transmits the deal advertisement to the wireless device 2825 of U1 (e.g., directly using Bluetooth®, with the Wi-Fi access point, with a cellular data plan, NFC, RFID, WiMax, or some other wireless method). Although this diagram shows the deal is advertised directly from the store to the shopper it could also have been transmitted indirectly via the deal advertising server as was described by reference to FIGS. 1 and 2, (3) Member U1 uses ad-hoc social networking (e.g., through using the ad-hoc social networking server 2830 and downloading/installing ad-hoc social networking application 860 on mobile device 2825 if it is not installed already) and finds a profile match with shopper N4 (with mobile device 2835). They start a chat session and agree to share the purchase of two gallons of milk, so each effectively pays $2 rather than $2.99. The first user (U1) makes the $4 payment, receives an electronic receipt for the purchase, and picks up the 2 milk items at the store. The second user (N4) then pays $2 to the first user (e.g., using phone-to-phone NFC payment, or cash) to get 1 milk from the first user.

FIG. 28 is generalized to the case where several shoppers transfer their shopping lists to the deal advertising server 2810, where each shopping list has one or more items on it. The advertising server then performs the function of a shopping list matcher by grouping list items from different shoppers and finding deals for them.

FIG. 29 conceptually illustrates deal advertising by several different deal advertising servers in some embodiments of the invention. The figure demonstrates embodiments where there are several different deal advertising servers 2905-2915 from different companies and a registered user, U1, is acting as a deal aggregator and commissioned agent by promoting deals from all three advertising servers to nearby users.

In FIG. 29 deal server X 2910 is advertising deal 1 from store A 2920 (e.g., through store A server 2950), deal server Y 2905 is advertising deal 2 from store E 2925 (e.g., through store E server 2955), and deal server Z 2915 is advertising package deal 3 from stores G 2930 and H 2935 (e.g., through store G server 2960 and store H server 2965). In other embodiments advertising servers X 2910, Y 2905 and Z 2915 belong to stores A 2920, E 2925 and G/H 2930/2935, respectively, where the stores are advertising their products directly to members such as U1. Servers X, Y and Z can have different referral interfaces from that shown in FIGS. 4 and 18, but all three servers provide a rewards mechanism to give incentives to members to make referrals.

In this example, user U1 is a registered member of all three servers and receives advertisements on his mobile device about all three deals. He logs into each of the three servers and obtains personalized referral information with reward sharing. He then uses his mobile device and P2P wireless communication to advertise all three deals. At time T0 user N2's mobile does profile matching with all three deals that are broadcast by U1's mobile, and finds a match with deal 1. At time T1 user N4's mobile does profile matching and finds matches with deals 1 and 2. And at time T2 user N9's mobile does profile matching and finds matches with deals 2 and 3. If users N2 112, N4 114 and N9 119 purchase these deals with U1's referrals then U1 receives the corresponding rewards from each deal advertising server.

### X. Position Determination

A mobile device communicates wirelessly with one or more of the networks in FIG. 1. The communication is either downlink from the network access points (meaning satellites, Wi-Fi access points, cellular towers, etc.) to the mobile device, or the uplink direction from the mobile device to the access points. In the downlink direction, the mobile device receives wireless signals and processes the signals into a location estimate. Alternatively, the mobile device sends the signal information to a location server for processing into a location estimate, where the server sends the location estimate back to the mobile device or forwards it to other servers. Typical information used for positioning includes Global Positioning System (GPS) signals, Received Signal Strength Indicator (RSSI), Angle Of Arrival (AOA), Time Of Arrival (TOA), Time Difference Of Arrival (TDOA), and Doppler shift. For example, triangulation is employed in some embodiments where multiple range or angle measurements from known positions are used to calculate the position of a device. If the users have set the security preferences of their mobile devices such that others can see their locations then either the location server requests and receives their location or the mobile devices broadcast their locations. A mobile's location is also estimated by its proximity to other mobile devices. For example, if mobile device A is communicating with mobile device B in a P2P mode without an access point then the two devices are in close proximity to each other. Thus, if the position of one of them is not known it can be estimated from the position of the other.

Image and video matching algorithms are also used in some embodiments to find the position of a mobile device. Many mobile devices have cameras that take images and videos. A mobile device in some embodiments has an application running that takes images/videos of its surroundings continuously or at different time instances. This content in some embodiments is compared to a reference image/video database to find the location of the device. The matching in some embodiments is performed on the mobile device, which requires the mobile device to download the reference database, or preferably on a server such as the location server 175 of FIG. 1. For example, a user entering a mall can download an application (if it has not been previously installed) from a mall access point that uses the mobile device to take images/video of nearby scenes. The mobile device then transmits the content to the location server using mall access points, mall Femtocell servers, another mobile that is acting as a base-station that connects to the cellular network, or directly (mobile device itself becomes a base station). The location server then compares the image/video content with a reference database of images/video from inside the mall to calculate the mobile device's position. This is particularly useful in multi-level story buildings where GPS calculated locations are coarse and do not show which level the mobile device is located at.

FIG. 30 conceptually illustrates a block diagram of a user's wireless mobile device in some embodiments of the invention. The mobile device 3000 includes one or more wireless radio devices 3005 with antenna 3010 that transmit and receive electromagnetic waves, and baseband transceivers 3015 that process the information. A processor 3020 controls the radios 3005. The mobile device has a location module application 3025 that processes the radio signals and calculates the position of the mobile at any given time.

The mobile device also has a magnetometer sensor that provides the orientation of the mobile device in three dimensions, and an accelerometer that calculates the velocity magnitude and angle (magnetometer and accelerometer are shown together as block 3090 for simplicity). The device has NFC circuitry 3030 for reading barcodes, smart cards, and interfacing with electronic payment systems. The mobile device memory 3035 has ROM for program storage and RAM for running programs. The operating system 3040 interfaces the hardware with the user and manages resources. Input devices 3045 of the mobile include keyboard and/or touch screen, microphone, and camera photo-sensors 3095 for still pictures and video. Output devices include a display 3050, speaker 3055, and wired or wireless headsets 3060. The mobile has a number of dedicated applications 3065 such as deal advertising, ad-hoc social networking, profile editor and matcher, server-based social networking, email, instant messenger, chat, SMS, and camera. The mobile also has a browser 3070 that can browse information on the intranet/Internet and download other applications from the network. There is a bus (not shown) that links all these components with the processor and memory. A section 3080 of the memory is dedicated to local storage of content such as pictures, video, audio, and email.

Some of the applications in FIG. 30 use the location module 3025 to tag the generated content with location information, the magnetometer to tag the content with 3D orientation information, and the accelerometer to tag the content with current velocity and velocity angle. They also use the date and time module 3075 to tag the content with a date and time stamp. The location module 3025 in some embodiments provides latitude and longitude information or some other coordinate system. The location module also converts the latitude/longitude information to street addresses for maps such as Google Maps™ in some embodiments.

One or more of the location coordinates, 3D orientation, velocity, and data/time information are included in the generated content, coded in the filename of the content, or stored and sent in a separate metafile or message that is associated with the content. Thus, content generated by applications such as email, chat, SMS, social networking tools, and the camera are complemented in some embodiments with location, orientation, velocity, and date/time information if the user/member chooses to do so by setting the appropriate security preferences at the content level or at the application level. The mobile device in some embodiments uploads the geotagged content for storage on networked geotagged user content databases 198 (shown in FIG. 1). Some of the user security preferences 3085 are stored locally on the mobile in some embodiments, while others are stored on user/member profile databases 195 (shown in FIG. 1) that are accessible to networked servers 182 and communication and content servers 162 (shown in FIG. 1) that provide applications (e.g., email, chat, social networking). If a member has disabled continuous position tracking but has enabled content tagging, then the uploaded geotagged content is used to extract position and velocity information in some embodiments.

### XI. Electronic System

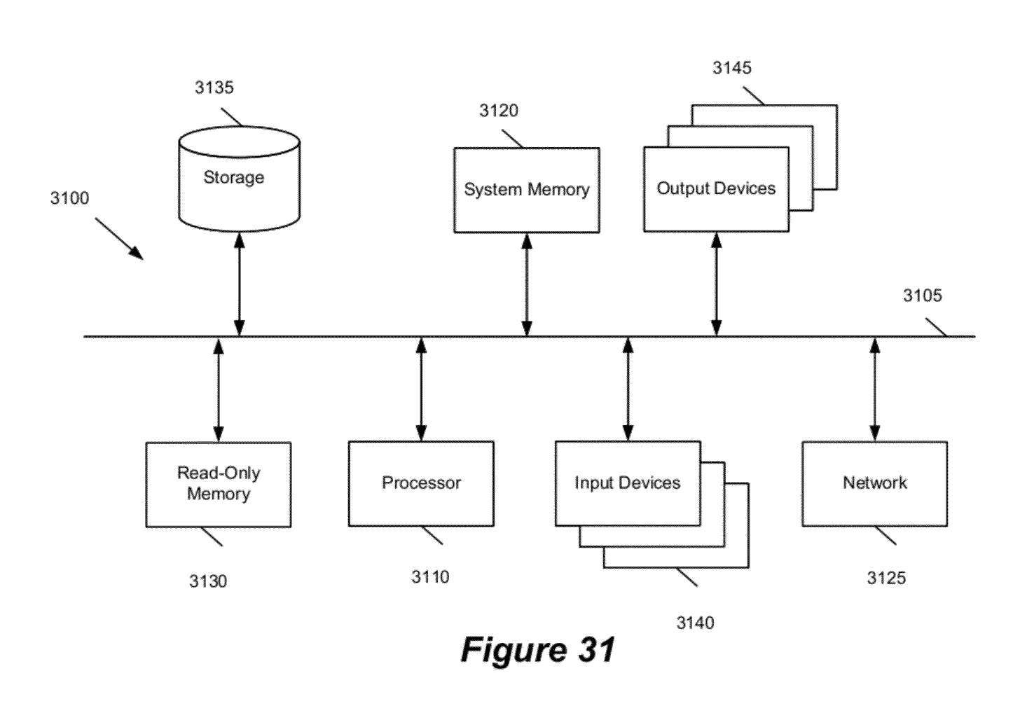

FIG. 31 conceptually illustrates an electronic system 3100 with which some embodiments of the invention are implemented. The electronic system 3100 may be a computer (e.g., a desktop computer, personal computer, tablet computer, server, etc.), phone, PDA, or any other sort of electronic or computing device. Such an electronic system includes various types of computer readable media and interfaces for various other types of computer readable media. Electronic system 3100 in some embodiments includes a bus 3105, processing unit(s) 3110, a system memory 3120, a network 3125, a read-only memory 3130, a permanent storage device 3135, input devices 3140, and output devices 3145.

The bus 3105 collectively represents all system, peripheral, and chipset buses that communicatively connect the numerous internal devices of the electronic system 3100. For instance, the bus 3105 communicatively connects the processing unit(s) 3110 with the read-only memory 3130, the system memory 3120, and the permanent storage device 3135.

From these various memory units, the processing unit(s) 3110 retrieves instructions to execute and data to process in order to execute the processes of the invention. The processing unit(s) may be a single processor or a multi-core processor in different embodiments.

The read-only-memory (ROM) 3130 stores static data and instructions that are needed by the processing unit(s) 3110 and other modules of the electronic system. The permanent storage device 3135, on the other hand, is a read-and-write memory device. This device is a non-volatile memory unit that stores instructions and data even when the electronic system 3100 is off. Some embodiments of the invention use a mass-storage device (such as a magnetic or optical disk and its corresponding disk drive) as the permanent storage device 3135.

Other embodiments use a removable storage device (such as a floppy disk, flash memory device, etc., and its corresponding disk drive) as the permanent storage device. Like the permanent storage device 3135, the system memory 3120 is a read-and-write memory device. However, unlike storage device 3135, the system memory 3120 is a volatile read-and-write memory, such a random access memory. The system memory 3120 stores some of the instructions and data that the processor needs at runtime. In some embodiments, the invention's processes are stored in the system memory 3120, the permanent storage device 3135, and/or the read-only memory 3130. For example, the various memory units include instructions for processing multimedia clips in accordance with some embodiments. From these various memory units, the processing unit(s) 3110 retrieves instructions to execute and data to process in order to execute the processes of some embodiments.

The bus 3105 also connects to the input and output devices 3140 and 3145. The input devices 3140 enable the user to communicate information and select commands to the electronic system. The input devices 3140 include alphanumeric keyboards and pointing devices (also called “cursor control devices”), cameras (e.g., webcams), microphones or similar devices for receiving voice commands, etc. The output devices 3145 display images generated by the electronic system or otherwise output data. The output devices 3145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 31, bus 3105 also couples electronic system 3100 to a network 3125 through a network adapter (not shown). In this manner, the computer can be a part of a network of computers (such as a local area network (“LAN”), a wide area network (“WAN”), or an Intranet, or a network of networks, such as the Internet. Any or all components of electronic system 3100 may be used in conjunction with the invention.

Many of the above-described features and applications are implemented as software processes that are specified as a set of instructions recorded on a computer readable storage medium (also referred to as computer readable medium, machine readable medium, machine readable storage). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of this specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (e.g., FIGS. 6, 7, 16, and 21-24) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A method of deal advertising, the method comprising:
estimating locations of a plurality of mobile devices;
grouping the plurality of mobile devices into groups of mobile devices based on the estimated locations;
identifying a deal from a set of stores that are within a particular distance from each mobile device in a particular group of mobile devices, wherein the deal requires a minimum number of buyers to purchase the deal, wherein said minimum number is more than a number of mobile devices in the particular group;
based on a prior history of referrals by users of the mobile devices in the particular group, determining an estimated number of referrals that the users of the mobile devices in the particular group are going to make for the identified deal;
determining an estimated number of referrals that result in a sale based on the estimated number of referrals that the users of the mobile devices in the particular group are going to make for the identified deal; and
sending the deal to the mobile devices in the particular group when a sum of the number of mobile devices in the particular group and said estimated number of referrals that result in a sale is equal to or exceeding the minimum number of buyers required to purchase the deal.

2. The method of claim 1, wherein the identified deal comprises (i) at least one product from each store in a plurality of stores in the set of stores and (ii) an option to add one or more products from the set of stores.

3. The method of claim 1, wherein the identified deal includes at least one product from each store in a plurality of stores in the set of stores, the method further comprising:
receiving an indication that a product included in the deal is no longer available;
updating the deal to remove the product that is no longer available from the deal; and
sending the updated deal to the mobile devices in the particular group.

4. The method of claim 1, wherein the identified deal includes at least one product from each store in a plurality of stores in the set of stores, the method further comprising:
receiving an identification of a product to be added to the deal;
updating the deal to add the identified product to the deal; and
sending the updated deal to the mobile devices in the particular group.

5. The method of claim 1, wherein the set of stores consists of one store, wherein the identified deal comprises (i) one or more products from said store and (ii) an option to add other products from said store.

6. The method of claim 1, wherein identifying the deal from the set of stores comprises:
identifying a set of products from the set of stores to include in the deal; and
computing a set of statistical measures for the set of stores, the statistical measures comprising a potential collective purchasing power of the users of the mobile devices in the particular group for the identified set of products.

7. The method of claim 1, wherein identifying the deal from the set of stores comprises computing a set of statistical measures for the set of stores, the statistical measures comprising a total amount that users of the mobile devices in the particular group are likely to spend at the stores in the set of stores to buy any products.

8. The method of claim 1, wherein identifying the deal from the set of stores comprises computing a set of statistical measures for the set of stores, the statistical measures comprising at least one of (i) a number of likely buyers for each store and (ii) an average value that each user of a mobile device in the particular group of mobile devices is likely to spend at each store in the set of stores.

9. The method of claim 1, wherein the plurality of mobile devices utilize a person-to-person network for sending referrals, wherein determining the estimated number of referrals that the users of the mobile devices in the particular group are going to make comprises estimating a number of referrals made by the users of the mobile devices in the particular group to a set of mobile devices communicatively coupled to the mobile devices in the particular group through the person-to-person network.

10. The method of claim 1 further comprising utilizing a data mining server for (i) computing a set of statistical measures for the user of the mobile devices in the particular group, (ii) recommending single or multiple products for the deal, and (iii) determining a deal advertising notification method for each mobile device in the particular group.

11. The method of claim 10, wherein the advertising notification method comprises one or more of utilizing email, text message, instant message, voice message, social networking, pull-based applications, a deal server's portal web pages, the deal server's messaging system.

12. The method of claim 1, wherein the identified deal is a first deal, wherein the estimated number of referrals that the users of the mobile devices in the particular group are going to make for the identified deal is a first estimated number of referrals that the users of the mobile devices in the particular group are going to make for the identified deal, wherein the estimated number of referrals that result in a sale is a first estimated number of referrals that result in a sale, the method further comprising:
removing a mobile device from the particular group when a distance between the mobile device and at least one store in the set of stores exceeds a threshold;
after removing the mobile device from the particular group, determining a second estimated number of referrals that the users of the mobile devices in the particular group are going to make for the identified deal;
determining a second estimated number of referrals that result in a sale based on the second estimated number of referrals that the users of the mobile devices in the particular group are going to make for the identified deal; and
determining that the sum of a current number of mobile devices in the particular group and said second estimated number of referrals that result in a sale is less than the minimum number of buyers required to purchase the first deal; and
replacing the first deal with a second deal, wherein the sum of the current number of mobile devices in the particular group and the second estimated number of referrals that result in a sale is equal to or exceeding the minimum number of buyers required to purchase the second deal.

13. The method of claim 1, wherein the identified deal is a first deal, wherein the estimated number of referrals that the users of the mobile devices in the particular group are going to make for the identified deal is a first estimated number of referrals that the users of the mobile devices in the particular group are going to make for the identified deal, wherein the estimated number of referrals that result in a sale is a first estimated number of referrals that result in a sale, the method further comprising:
removing a mobile device from the particular group when a distance between the mobile device and at least one store in the set of stores exceeds a threshold;
after removing the mobile device from the particular group, determining a second estimated number of referrals that the users of the mobile devices in the particular group are going to make for the identified deal;
determining a second estimated number of referrals that result in a sale based on the second estimated number of referrals that the users of the mobile devices in the particular group are going to make for the identified deal; and
determining that the sum of a current number of mobile devices in the particular group and said second estimated number of referrals that result in a sale is less than the minimum number of buyers required to purchase the first deal; and
replacing the first deal with a second deal, wherein the second deal does not require a minimum number of buyers to purchase the second deal.

14. The method of claim 1, wherein grouping the plurality of mobile devices into groups of mobile devices is further based on a shopping history of the users of the mobile devices in each group, wherein the identified deal includes one or more products selected based on the shopping history of the users of the mobile devices in the particular group.

15. A machine readable medium storing a program for deal advertising, the program executable by at least one processing unit, the program comprising sets of instructions for:
estimating locations of a plurality of mobile devices;
grouping the plurality of mobile devices into groups of mobile devices based on the estimated locations;
identifying a deal from a set of stores that are within a particular distance from each mobile device in a particular group of mobile devices, wherein the deal comprises a set of products, wherein the deal requires a minimum amount of money for purchasing the set of products;
determining, based on a prior history of referrals by users of the mobile devices in the particular group, an estimated amount of money that a set of referrals are going to spend for the identified deal;
determining an estimated number of referrals that result in a sale based on the estimated number of referrals that the users of the mobile devices in the particular group are going to make for the identified deal; and
sending the deal to the mobile devices in the particular group when a sum of an estimated amount of money that the users of the mobile devices in the plurality of mobile device are going to spend for the identified deal and the estimated amount of money that a set of referrals that result in a sale are going to spend for the identified deal is equal to or exceeding the minimum amount of money required by the deal.

16. The machine readable medium of claim 15, wherein the plurality of mobile devices utilize a person-to-person network for sending referrals, wherein the set of instructions for determining an estimated amount of money that a set of referrals are going to spend for the identified deal comprises a set of instructions for estimating a number of referrals made by the users of the mobile devices in the particular group to a set of mobile devices communicatively coupled to the mobile devices in the particular group through the person-to-person network.

17. The machine readable medium of claim 15, wherein grouping the plurality of mobile devices into groups of mobile devices is further based on a shopping history of the users of the mobile devices in each group, wherein the identified deal includes one or more products selected based on the shopping history of the users of the mobile devices in the particular group.

18. The machine readable medium of claim 15, wherein the identified deal comprises (i) at least one product from each store in a plurality of stores in the set of stores and (ii) an option to add one or more products from the set of stores.

19. The machine readable medium of claim 15, wherein the identified deal includes at least one product from each store in a plurality of stores in the set of stores, wherein the program further comprises sets of instructions for:
receiving an indication at a product included in the deal is no longer available;
updating the deal to remove the product that is no longer available from the deal; and
sending the updated deal to the mobile devices in the particular group.

20. The machine readable medium of claim 15, wherein the identified deal includes at least one product from each store in a plurality of stores in the set of stores, wherein the program further comprises sets of instructions for:
receiving an identification of a product to be included in the deal;
updating the deal to add the identified product; and
sending the updated deal to the mobile devices in the particular group.

21. The machine readable medium of claim 15, wherein the program further comprises sets of instructions for sending a graphical map to each mobile device in the particular group, the graphical map identifying (i) a location of each store in the set of stores and (ii) at least one product in the deal.

22. The machine readable medium of claim 21, wherein the program further comprises sets of instructions for periodically updating the graphical map sent to each mobile device based on a current location of the mobile device.

23. The machine readable medium of claim 21, wherein the program further comprises sets of instructions for periodically updating the graphical map sent to each mobile device based on a change in the deal.

24. The machine readable medium of claim 21, wherein the graphical map sent to each particular mobile device further identifies (i) a current location of the particular mobile device and (ii) directions from the current location of the mobile device to a store offering said at least one product.

25. The machine readable medium of claim 21, the graphical map sent to each particular mobile device is further for manually navigating the map by providing address, zooming and scrolling when location tracking is disabled by a user of the particular mobile device.

26. A method of deal advertising, the method comprising:
receiving a deal for purchasing a set of products from a store, the deal requiring a minimum amount of money for purchasing the set of products;
identifying a plurality of mobile devices that are within a particular distance from the store;
based on a set of statistical measures, computing an estimated amount of money that users of the mobile devices in the plurality of mobile devices are likely to spend on the deal;
based on a prior history of referrals by the users of the mobile devices in the plurality of mobile devices, determining an estimated amount of money that a set of referrals are likely to spend on the deal; and
sending the deal to the mobile devices in the plurality of mobile devices when a sum of the estimated amount of money that the users of the mobile devices in the plurality of mobile devices are likely to spend on the deal and the estimated amount of money that the set of referrals are likely to spend on the deal is equal to or exceeding the minimum amount of money required for purchasing the set of products.

27. The method of claim 26, wherein the plurality of mobile devices utilizes a person-to-person network for sending referrals, wherein determining an estimated amount of money that a set of referrals are likely to spend on the deal comprises:
estimating a number of referrals made by the users of the mobile devices in the plurality of mobile devices to a set of mobile devices communicatively coupled to the mobile devices in the plurality of mobile devices through the person-to-person network; and
estimating a number of referrals that result in a sale through the person-to-person network based on the estimated number of referrals that the users of the mobile devices in the particular group are going to make for the identified deal through the person-to-person network;

28. The method of claim 26, wherein computing the estimated amount of money that users are likely to spend comprises utilizing users' (i) profiles, (ii) location history, (iii) usage history of prior deals, (iv) prior purchases, (v) shopping lists, and (vi) wish lists.

29. The method of claim 26, wherein a mobile device is one of a wireless phone, tablet personal computer (PC), personal digital assistant (PDA), PC laptop, personal audio device, personal video device, digital still camera, and digital video camera.
